(19) United States
(12) Patent Application Publication
(10) Pub. No.: US 2025/0040764 A1
(43) Pub. Date: Feb. 6, 2025

(54) Plant Based Milk System

(71) Applicant: Intohealth International Pty Ltd, Bondi Junction (AU)

(72) Inventors: Yaron REMEN, Bondi Junction (AU); Iain McDONALD, Bondi Junction (AU)

(21) Appl. No.: 18/920,855

(22) Filed: Oct. 19, 2024

Related U.S. Application Data
(63) Continuation of application No. PCT/AU2023/050330, filed on Apr. 21, 2023.

(30) Foreign Application Priority Data
Apr. 21, 2022 (AU) 2022901051

(51) Int. Cl. A47J 43/07; A47J 43/044

(52) U.S. Cl. CPC A47J 43/0711; A47J 43/044; A47J 2043/04454

(57) ABSTRACT

An apparatus, system and method for forming a plant based milk. The apparatus includes a base that is configured to receive a vessel and a mixing head configured to mix a liquid and a concentrate in the vessel. The mixing head may comprise a rotor within a stator screen. The mixing head may be configured to shear and/or emulsify the concentrate in the liquid.

### CROSS-REFERENCE TO RELATED APPLICATIONS

This application is a bypass continuation of International PCT Application No. PCT/AU2023/050330, filed on Apr. 21, 2023, which claims priority to Australian Patent Application No. 2022901051, filed on 21 Apr. 2022, which are incorporated by reference herein in their entirety.

### TECHNICAL FIELD

The invention relates generally to a system, apparatus and/or method for forming a plant based milk from a concentrated substance and in particular to a system, apparatus and/or method for combining a plant based milk concentrate with water to form a plant based milk on demand.

### BACKGROUND OF INVENTION

Some consumers are lactose intolerant or otherwise unable to consume cow's milk and therefore need an alternative product to drink or use in tea, coffee, smoothies or add to breakfast cereals, for example. Plant based milks have rapidly grown in popularity in recent years as a substitute for cow's milk. Some consumers also view plant based milks as a healthier, friendlier to animal welfare and/or sustainable alternative to cow's milk. Common plant based milks include almond milk, coconut milk, oat milk, soy milk and rice milk.

Cafes and restaurants generally offer a number of plant based milks as an alternative to cow's milk. Plant based milks are common in the refrigerator section of a supermarket adjacent to cow's milk and in similar sized and looking containers. Plant based milks are also usually found outside of the refrigerator on supermarket shelves in long life form, usually in sizes around 1 litre.

In addition, plant based milk concentrates, generally in paste or powder form, are less common than ready to drink plant based milks. The use of concentrates may prevent or reduce the need for preservatives, added sugar or other unwanted additional materials that can affect the taste or health benefits of a plant based milk. A concentrated plant based milk product may also reduce shelf space needed for storage and may have a long shelf life. A drawback of concentrated plant based milks substances, such as powders or pastes, is that they may be difficult to combine with water to form a satisfactory or stable milk product. There is also an amount of effort on the part of the consumer required to make a drinkable plant based milk from a concentrate.

Some existing machines that form plant based milk use raw plant based materials, such as almonds, soybeans, oats etc. The raw materials are pulverised and mixed with water, and often other additives and preservatives, at high temperatures. This process is very energy intensive and is generally not suitable to be performed in a café or home environment and is, generally, more suited to being performed in a factory. Such machines are also very complicated, expensive and take up a large amount of space.

It is desirable to overcome one or more of the problems associated with existing plant based milk apparatus, or to provide a useful alternative. Preferably, it is desirable to provide a system, apparatus and/or method that allows a consumer to readily or conveniently prepare a plant based milk from a concentrate.

### SUMMARY OF INVENTION

An aspect of the present disclosure provides portable an apparatus for forming a plant based milk, comprising: a housing including a base that is configured to receive a vessel; a mixing head configured to mix a liquid and a concentrate in the vessel, wherein the mixing head comprises a rotor within a stator screen, and wherein the mixing head is configured to shear and/or emulsify the concentrate in the liquid

A further aspect of the present disclosure provides An apparatus for forming a plant based milk, comprising: a housing comprising a base; a vessel, wherein the base is configured to receive the vessel; a mixing head within the vessel; and a cap configured to enclose an opening of the vessel, wherein the cap is configured to receive a container of concentrate, and wherein the mixing head is configured to mix a liquid and the concentrate in the vessel.

A further aspect of the present disclosure provides an apparatus for forming a plant based milk, comprising: a housing having a base that is configured to receive a vessel; a mixing head configured to mix a concentrate comprising a plant material and a liquid in the vessel.

Another aspect of the present disclosure provides an apparatus for forming a plant based milk, comprising: a housing adapted to receive a concentrate, the concentrate comprising a concentrated plant material; and a mixing head adapted to mix the concentrate and a liquid, wherein the housing is adapted to receive a vessel containing the liquid and to dispense the concentrate into the vessel, the mixing head being adapted to protrude into an opening of the vessel when the vessel is received by the housing such that the mixing head can mix the concentrate and the liquid to form the plant based milk inside the vessel.

Another aspect of the present disclosure provides an apparatus for forming a plant based milk, comprising: a housing adapted to receive a concentrate, the concentrate being in the form of a powder or a paste, and the concentrate comprising a concentrated plant material; and a mixing head adapted to mix the concentrate with a liquid to form the plant based milk in the housing or in a vessel received by the housing.

The features of any one of more of the above aspects may be further combined with any one or more of the following embodiments and/or any other feature of an apparatus for forming a plant based milk as described herein.

According to embodiments, the concentrate is in the form of a concentrated liquid, or a powder or a paste. The concentrate may be a powder. The concentrate may be a paste.

According to embodiments, the liquid is water. The liquid may be placed into the vessel by a user prior to the vessel being placed onto or into the apparatus.

According to embodiments, the apparatus is portable. Herein, the term portable may be used to mean an apparatus that is easily transported, stored away or carried in a bag by a user. The portable apparatus may be of a size and weight that make it easy for a user to carry. The portable apparatus is differentiated from a kitchen benchtop apparatus and is more transportable to other settings for use. It is preferable that the portable apparatus comprises an internal power source and/or has a rechargeable battery rather than requiring a permanent wired connection to a power outlet to function.

According to embodiments, the housing of the apparatus consists of a base. The base may be substantially or entirely located adjacent to an end of the vessel when the vessel is positioned in or on the base. The base may be substantially or entirely located adjacent to a lower end of the vessel when the vessel is positioned in or on the base.

According to embodiments, the housing is adapted to receive a vessel containing the liquid and to dispense the concentrate into the vessel, and wherein the mixing head is adapted to protrude into an opening of the vessel when the vessel is received by the housing such that the mixing head can mix the concentrate and the liquid inside the vessel.

The apparatus may comprise a base. The base may have a seat region which is configured to receive a vessel. The vessel may be configured to dock within the base. The base and/or vessel may be configured to include a docking mechanism. The base and/or vessel may be configured to releasably lock together. The vessel and/or base may include a threaded engagement such that the vessel may be twisted relative to the base to dock and/or lock together.

According to embodiments, the apparatus comprises the vessel. The vessel may be any one a bottle, a flask, a container, a jar, a cup and/or a mug. The vessel may be a bottle. The vessel may be at least partially transparent or translucent. The bottle may be formed from any one of more of: a metal or metals, stainless steel, glass, plastic, a polymer and/or PET (polyethylene terephthalate). The bottle may be formed at least partially from PET.

According to embodiments, the mixing head is within the vessel. The mixing head may be attached to an end of the vessel. The end of the vessel may be a lower end of the vessel, when in an in use or upright orientation. The mixing head may be connected to a lid, or enclosure for an opening of the vessel. The mixing head may be connected to a rotating connector. The rotating connector may be located at the end of the vessel and/or a lower end of the vessel. The rotating connector may be rotatably connected to the mixing head. The rotating connector may be located outside of an internal volume of the vessel and/or the mixing head may be located inside an internal volume of the vessel. The rotating connector may be outside of the internal volume of the vessel relative to a lid or enclosure of the vessel. The mixing head may be inside the internal volume relative to the lid or enclosure of the vessel. The lid or enclosure of the vessel may be located at a lower end of the vessel when in use and/or when positioned on a base of the apparatus. The rotating connector of the vessel may engage with a corresponding rotating connector located on the base when the vessel is seated on the base. The rotating connectors of the vessel and base may be configured to transfer a rotational motion of a motor to a the rotor of the mixing head.

According to embodiments, the mixing head comprises a rotor within a stator screen. The mixing head may be configured to shear and/or emulsify the concentrate in the liquid. The rotor may comprise a plurality of rotating blades. The stator screen may comprise a plurality of apertures. According to embodiments, each aperture in the stator screen is about 1.0 mm to 1.5 mm in diameter. The apertures in the stator screen may be about 0.5 to 5 mm in diameter, or may be about 0.5 to 3 mm in diameter, or may be about 1 to 2 mm in diameter or about 1 to 1.5 mm in diameter, or any suitable value above, below or within these sizes ranges. According to embodiments, at least one surface of the rotor has a small clearance from the stator screen. The small clearance between the rotor and the stator screen may be less than 2 mm, less than 1.5 mm, less than 1 mm, less than 0.5 mm, less than 0.3 mm, less than 0.2 mm and/or less than 0.1 mm. The small clearance between the rotor and the stator screen may create a high sheer when the mixing head is in operation.

According to embodiments, the apparatus comprises a motor configured to transfer a rotational movement to the mixing head. The motor may transfer a rotational motion to a rotor of the mixing head. The motor may be housed within the base. The motor may be configured to rotate the rotor. A lower end of the vessel may comprise a rotating connector which is configured to engage with a corresponding rotating connector located on the base. The rotating connectors of the vessel and base may be configured to transfer the rotational motion of the motor to the rotor of the mixing head. The motor may be configured to rotate the rotor at a speed of at least 1000 RPM, optionally at least 2000 RPM, optionally at least 2500 RPM, optionally at least 3000 RPM, optionally at least 4000 RPM, optionally at least 5000 RPM, optionally at least 7500 RPM, optionally at least 10,000 RPM, optionally at least 15,000 RPM, optionally from about 5000 to about 20,000 RPM, optionally from about 10,000 to about 15,000 RPM, optionally from about 15,000 to about 20,000 RPM, and/or optionally from about 10,000 RPM to about 20,000 RPM. According to embodiments, the motor is geared. The motor may be configured to enable a gradual increase and decrease of the speed of rotation of the blade.

According to embodiments, the apparatus may include an internal power source. The internal power source may comprise at least one battery. The internal power source may be a rechargeable battery. The internal power source may be located within the base of the apparatus. The internal power source may be configured to power the motor. According to embodiments, the apparatus may be powered by a mains power supply and/or through a cable connection from a power supply to the apparatus. The motor may be powered by a mains power supply and/or through a cable connection from a power supply to the apparatus.

According to embodiments, the apparatus comprises a cap. The cap may be configured to enclose an opening in an end of the vessel. The end of the vessel enclosed by the cap may be an upper end of the vessel. The end of the vessel enclosed by the cap may be an opposite end of the vessel to where the mixing head is located. The cap may be configured to receive a container of concentrate. The container of concentrate may be received into an internal cavity of the cap. The cap may comprise an entrance through which the container of concentrate may be received. The entrance may be configured to allow the container to be inserted into the internal cavity of the cap.

According to embodiments, the apparatus comprises an opener that is configured to open a container of concentrate. According to embodiments, the opener is a piercer, or a blade, or a knife, or a cutter. According to embodiments, the opener may tear the container. The opener may pierce and/or cut the container of concentrate. The opener opening the container may permit a concentrate to be dispensed from the opened container. The cap may comprise the opener. The opener may be located within the cap. The opener may be located within and/or adjacent to the internal cavity of the cap. The opener may be configured to open and/or pierce the container within the internal cavity of the cap.

According to embodiments, the apparatus comprise an extraction mechanism to extract a concentrate from the container. The extraction mechanism may extract the concentrate from the container after the container has been opened. The extraction mechanism may be in the cap. The extraction mechanism may be used to extract the concentrate after the opener has pierced or opened the container. The extraction mechanism may cause the concentrate to dispense form the container into the vessel. According to embodiments, the mechanism may comprise two surfaces between which a receiving section of the apparatus configured to receive the container of concentrate is at least partially located The extraction mechanism may be configured to compress the container between the two surfaces to cause the concentrate to be dispensed. According to embodiments, the extraction mechanism may comprise two surfaces of the cap between which the internal cavity of the cap is at least partially located. The extraction mechanism may be configured to compress the container between the two surfaces to cause the concentrate to be dispensed. The cap may comprise at least one aperture through which a concentrate from a container may be dispensed into the vessel. The at least one aperture of the cap may provide a fluid communication between the internal cavity of the cap and an internal volume of the vessel. According to embodiments, the apparatus includes a plunger. The plunger may be pressed to cause at least a first surface of the two surfaces to move towards a second surface of the two surfaces.

According to embodiments, the cap is connected to the base only indirectly via the vessel. According to embodiments the cap and the base are not directly connected to one another. According to embodiments, the cap is distanced and/or spaced apart from the housing and/or from the base.

According to embodiments, the housing of the apparatus is located entirely adjacent to a first end of the vessel when the vessel is in position on the base. The first end of the vessel may comprise the mixing head. The cap may be located at a second end of the vessel in use. The second end of the vessel may be at an opposed end of the vessel from the first end.

According to embodiments of the present disclosure, the housing comprises an aperture adapted to receive a container that contains the concentrate. The aperture may be located in an upper part of the housing. the upper part is configured to dispense the concentrate from the container into a vessel positioned on the base. The upper part may be configured to gradually dispense the concentrate from the container into the vessel. The upper part may comprise a receiver that receives the container. The receiver may be configured to rotate upon actuation to cause the concentrate to be dispensed through an opening of the container. The upper part may comprise a funnel. The funnel may be configured to receive the concentrate dispensed from the container and to direct the concentrate into the vessel. The upper part may comprise an opener configured to open the container when received by the upper part. The upper part of the apparatus may be a cap. The upper part of the apparatus may be connected to and/or a part of the housing.

According to embodiments, the apparatus further comprises a receptacle configured to receive a container after the concentrate in the container has been dispensed and/or the container has been emptied.

According to embodiments of the present disclosure, the container is selected from one of a packet, a sachet, a pouch, a capsule or a pod. Optionally, the container is a stick pouch. According to embodiments, the housing comprises an opener adapted to open the container such that the concentrate is released from the container within the housing. The concentrate may dispense into the vessel when released from the container. The concentrate may be released from the container at least partially by a force applied by the apparatus. The concentrate may be released from the container at least partially by the force of gravity. Optionally, the opener comprises a blade for piercing the container. The opener may be part of an opening mechanism. The opener may be powered by a motor of the apparatus.

According to embodiments, the apparatus comprises a tray that is adapted to extend from and retract into the aperture in the housing. The tray may be adapted to receive the container when in an extended orientation.

According to embodiments, the apparatus comprises a receptacle adapted to receive a used container when the concentrate has been dispensed from the container.

According to embodiments, the mixing head comprises a stirring blade adapted to rotate at a high velocity. According to embodiments, the stirring blade is adapted to rotate at a speed of at least 500 RPM. The stirring blade may be adapted to rotate at a speed of at least 1000 RPM. The stirring blade may be adapted to rotate at a speed of at least 1500 RPM. The stirring blade may be adapted to rotate at a speed of about 2000 RPM. The stirring blade may be adapted to rotate at a speed of least 2000 RPM. The stirring blade may be adapted to rotate at a speed of least 2500 RPM. According to embodiments, the apparatus comprises a motor which is adapted to rotate the stirring blade.

According to embodiments, the mixing head comprises a stator screen having plurality of apertures adapted to reduce occurrence of lumps in the concentrate mixed with the liquid. The apertures of the stator screen may be about 1.0 mm to 1.5 mm in diameter. A surface of the stirring blade may be adapted to rotate within the stator screen of the mixing head. The surface of the stirring blade may have a small clearance. The small clearance may be less than 2 mm. The small clearance may be less than 1.5 mm. The small clearance may be less than 1 mm. The small clearance may be less than 0.5 mm. The small clearance between the surface of the stirring blade and the stator screen may create a high shear.

According to embodiments, the liquid is a water which is provided within the vessel by a user of the apparatus.

According to embodiments, the mixing head is adapted to move from a first position where it is at least partially contained within the housing to a second position where it is at least partially within the vessel received by the housing. According to embodiments, a mechanical means is provided for moving the mixing head between the first position and the second position. According to embodiments, an electrical means is provided for moving the mixing head between the first position and the second position. According to embodiments, a user operated means is provided which is adapted to move the mixing head between the first position and the second position. The user operated means may be a handle adapted to be manoeuvred by the user.

According to embodiments, the apparatus comprises a retention means adapted to retain the vessel received by the housing in a position relative to the housing when the concentrate and liquid are being mixed.

According to embodiments, the apparatus comprises a mixing container in which the mixing head is located. According to embodiments, the apparatus is adapted to receive a vessel positioned to substantially surround at least a part of the mixing container. According to embodiments, the mixing container is configured to release the plant based milk into the vessel after the concentrate and the liquid have been mixed. According to embodiments, the mixing container comprises a filter adapted to filter the plant based milk when released into the vessel. The apparatus may comprise a tank adapted to hold the liquid. According to embodiments, the apparatus comprises a pump adapted to pump the liquid from the tank to the mixing container.

Another aspect provides a container adapted for use with the apparatus of one or more of the above aspects or embodiments, wherein the container comprises a piercing region adapted to be pierced or cut by the blade of the opener of the apparatus.

According to a further aspect of the present disclosure there is provided a method for forming a plant based milk, comprising: providing the apparatus according to any one of the above aspects and/or embodiments; providing a plant based milk concentrate in a container; providing a liquid, preferably water, in a vessel; mixing the plant based milk concentrate with the liquid in the vessel to form a plant based milk.

According to embodiments, the method further comprises loading the vessel into a receiving area of the apparatus.

According to embodiments, the method further comprises dispensing the concentrate from the container into the vessel. The concentrate may be dispensed into the vessel when the vessel is received in the receiving area and/or a base of the apparatus.

According to embodiments, the method further comprises positioning the mixing head within the vessel and operating the mixing head such that the mixing head mixes the concentrate and liquid within the vessel to form the plant based milk.

According to embodiments, the method may include operating the mixing head at sufficient speed of rotation to cause an emulsification and/or shearing of the concentrate within the liquid.

A further aspect of the present disclosure provides a system for forming a plant based milk, comprising: the apparatus of any one of the above aspects and/or embodiments; a container containing the concentrate; and a vessel containing a liquid, preferably water; wherein the container is received by the apparatus and the concentrate within the container is dispensed by the apparatus into the liquid in the vessel, and the mixing head mixes the concentrate with the liquid to form the plant based milk in the vessel.

The vessel may be any suitable vessel from which the plant based milk can be either dispensed by the user or drunk directly from the vessel. The vessel may be a bottle. The vessel may have an upper opening through which the vessel receives the concentrate. The upper opening of the vessel may receive the mixing head of the apparatus such that the liquid and concentrate within the vessel may be mixed by the mixing head within the vessel. When the plant based milk has been formed within the vessel and the mixing head is no longer performing a mixing operation, the vessel may be removed from the apparatus by the user.

Accordingly, an aspect of the present disclosure provides an apparatus for forming a plant based milk, comprising: a housing adapted to receive a concentrate capsule, comprising plant material, and a liquid; a mixer comprising a mixing head and adapted to mix a concentrate from the concentrate capsule and liquid from the housing to form the plant based milk.

According to embodiments, the concentrate is a powder or a paste.

According to embodiments the concentrate capsule may be a sachet, a pod, a frangible container or other container capable of being inserted into the apparatus. The housing may include a port adapted to receive the concentrate capsule. The housing may include a tray adapted to extend outwardly from and retract inwardly to the housing. The tray may be adapted to receive the concentrate capsule. The housing may include an opener adapted to open the concentrate container such that the concentrate is released from the concentrate capsule. Preferably, the concentrate is released from the concentrate capsule by the opener towards the mixer. Optionally, the opener comprises a blade for piercing and/or cutting the concentrate container, such that its contents are available for release. The concentrate capsule may comprise a piercing region adapted to be pierced by the blade. The concentrate capsule may comprise a frangible region adapted to be ruptured to release the concentrate.

According to embodiments, the mixing head comprises a stirring blade. The stirring blade may be adapted to rotate at a high velocity. Optionally, the stirring blade is adapted to rotate at a speed of at least 500 RPM, preferably at least 1000 RPM, more preferably at least 1500 RPM, even more preferably about 2000 RPM, optionally at least 2000 RPM, optionally at least 2500 RPM, optionally at least 3000 RPM, optionally at least 4000 RPM, optionally at least 5000 RPM, optionally at least 7500 RPM, optionally at least 10,000 RPM, optionally at least 15,000 RPM, optionally from about 5000 to about 20,000 RPM, and/or optionally from about 10,000 RPM to about 20,000 RPM.

According to embodiments, the mixing head comprises a stator screen. The stator screen may have a plurality of apertures. The apertures may be adapted to reduce occurrence of lumps in the concentrate mixed with the liquid. Optionally the apertures are about 1.0 mm to 1.5 mm in diameter. Optionally, a surface of the stirring blade is adapted to rotate within the stator screen of the mixer. The surface of the stirring blade may have a small clearance from the stator screen. The small clearance between the surface of the stirring blade and the stator screen preferably creates a high shear.

According to embodiments, the mixer comprises a mixing container in which the mixing head is located or can be inserted. The mixing container may be made from stainless steel. The mixing container may be removable from the apparatus for cleaning. The mixing head may comprise stainless steel components. In other words, a mixing blade and a stator of the mixer may be formed form stainless steel. The mixing head may be removable from the apparatus.

According to embodiments, the apparatus is adapted to receive a milk container. Preferably, the mixer is configured to release the plant based milk into the milk container after the concentrate and the liquid have been mixed or to mix the concentrate and the liquid in the milk container to form the plant based milk. The milk container may be positioned to substantially surround at least a part of the mixer when received by the apparatus. The milk container may be positioned below the mixer when received by the apparatus. The milk container may have an opening located below the mixer when received by the apparatus. Optionally, the mixer is located at least partly inside the housing. The mixer may be located wholly inside the housing. When received by the apparatus the milk container may be located in a substantially open section permitting the milk container to be readily gripped and removed from the apparatus by user. The mixer may comprise a filter adapted to filter the plant based milk. The mixer may comprise a filter adapted to filter the plant based milk when released into the milk container.

According to embodiments, the apparatus comprises a motor. The motor may be adapted to rotate the stirring blade.

According to embodiments, the apparatus comprises a tank adapted to hold the liquid. Preferably, wherein the liquid is water. The tank may be a water tank. The tank may be releasably attached to the housing.

According to embodiments, the apparatus comprises a pump. The pump may be adapted to pump the liquid from a liquid container to the mixer. The pump may be adapted to pump the liquid from the tank to the mixer. The pump may be adapted to pump the mixed plant based milk from the mixer to the milk container.

According to another aspect of the present disclosure, there is provided an apparatus for forming a plant based milk, comprising: a housing adapted to receive a concentrate and a liquid; a mixer connected to the housing and receiving the concentrate and liquid from the housing, the mixer comprising a mixing head adapted to mix the concentrate and liquid to form the plant based milk. Alternatively according to this aspect, there is provided an apparatus for forming a plant based milk, comprising: a housing adapted to receive a concentrate and a liquid; a mixer comprising a mixing head and adapted to mix the concentrate and liquid from the housing to form the plant based milk.

The apparatus according to this aspect may further comprise any of the features as discussed in the above aspect or embodiments.

Another aspect of the present disclosure provides a method for forming a plant based milk, comprising: providing an apparatus according to any one or more of the above aspects or embodiments; providing a plant based milk concentrate; providing a liquid, preferably water; mixing the plant based milk concentrate with the liquid in the mixer of the apparatus to form a plant based milk. Optionally, the method comprises dispensing the plant based milk concentrate from the apparatus into a milk container.

A further aspect of the present disclosure provides a system for forming a plant based milk, comprising: an apparatus according to any one or more of the above aspects or embodiments; a plant based milk concentrate; and a liquid, preferably water; wherein the concentrate is received by the apparatus and is delivered to a mixer of the apparatus, the water is delivered to the mixer, and a mixing head of the mixer mixes the concentrate with the liquid to form the plant based milk.

Another aspect of the present disclosure provides a concentrate capsule adapted for use in an apparatus according to any one or more of the above aspects and embodiments. The concentrate capsule may be any one or more of a sachet, a pod, a frangible container, a pouch, or a packet. The container may be a sachet. The concentrate container may comprise a piercing region adapted to be pierced by a blade of the apparatus.

Embodiments of the present disclosure may be advantageous over existing apparatus because it may permit a chilled or room temperature plant based milk product to be formed. In addition, embodiments of the present disclosure may permit smaller quantities of plant based milk to be formed on demand than may be possible using existing machines that form a plant based milk from raw ingredients using high temperatures. Embodiments of the disclosure may be portable. According to embodiments, by permitting plant based milk to be formed on demand, the resulting plant based milk may be created whenever required for use and without requiring the addition of preservations and this may overcome problems with shelf life or added preservatives of preprepared plant based milk products. The plant based milk concentrate, such as a powder or paste, may itself have a long shelf life in its container. The apparatus according to embodiments of the present disclosure may be compact and inexpensive to produce compared to previous apparatus and may be used in numerous locations and settings, including in the home.

Further aspects and/or embodiments of the present disclosure may become clear to a person skilled in the art based on the detailed description which follows.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 shows a plant based milk forming system according to a first embodiment of the present disclosure;

FIG. 2 shows a plant based milk forming system according to a second embodiment of the present disclosure;

FIG. 3 shows a mixing head that may be used with a plant based milk forming system of the present disclosure;

FIG. 4 is a stator screen that may be used with a mixing head of a plant based milk forming system of the present disclosure;

FIG. 5 is an exploded view of a plant based milk apparatus according to the present disclosure;

FIG. 6 shows a perspective view of the plant based milk apparatus of FIG. 5;

FIG. 7 shows a side view of the plant based milk apparatus of FIG. 5;

FIG. 8 shows a front view of the plant based milk apparatus of FIG. 5;

FIG. 9 shows a perspective view of a further example of a plant based milk apparatus of the present disclosure;

FIG. 10 shows a schematic view of a plant based milk apparatus including a mechanism for dispensing a plant based milk substance from a container;

FIG. 11 shows a flow within a mechanism for removing a plant based milk substance from a container;

FIG. 12 shows a perspective view of another example of a plant based milk apparatus according to the present disclosure; and

FIGS. 13 to 17 show schematic views of a plant based milk apparatus including a mechanism for dispensing a plant based milk substance from a container.

### DETAILED DESCRIPTION

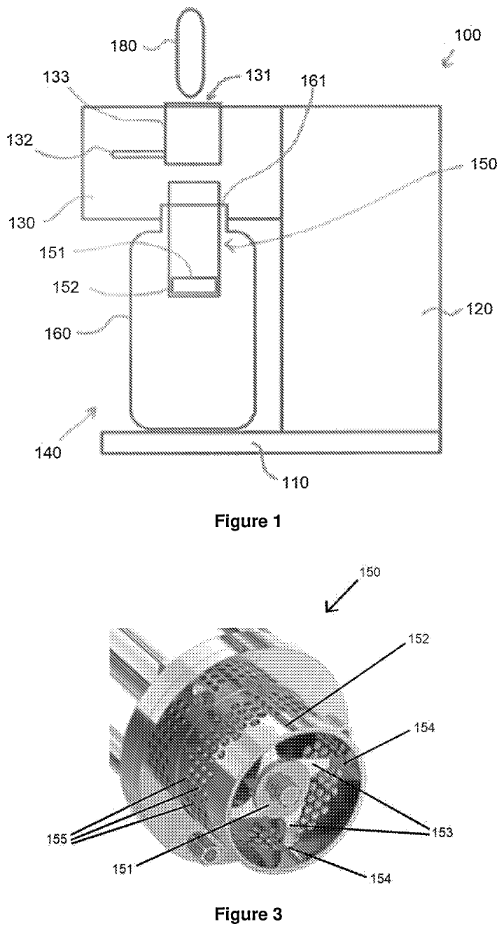

FIG. 1 depicts an exemplary system for forming a plant based milk comprising an apparatus 100. The apparatus 100 has a housing that includes a base 110, main body 120 and upper section 130. The apparatus 100 is adapted to receive a plant based milk concentrate. The plant based milk concentrate being provided to the apparatus in a container 180. The container 180 may be any one of a sachet, a capsule, pod, packet, stick pouch or other suitable container. In the embodiment shown in FIG. 1 the container 180 of plant based milk concentrate is a stick pouch. The plant based milk concentrate may be in the form of a powder in this embodiment or in the form of a paste.

The plant based milk concentrate may be any suitably concentrated plant based substance which will form a milk when mixed with water. It is generally preferred that the concentrate is a powder or a paste. The powder is a dry dehydrated plant based particulate material. According to embodiments, the concentrate could be a pulp or paste material or any other plant based concentrate substance. A possible advantage of using a powder over pulp or paste substances is that the powder may be less sticky and may be less likely to adhere to surfaces within the apparatus as it is a dry substance. A powder may be more easily flowable than a pulp or paste material when poured. This means that a powder may flow out of its container more easily, such as through the force of gravity, and may not require an additional force applied by the apparatus to be removed from the container, such as a capsule, as may be necessary to remove all of a sticky substance such as a paste or pulp from a container. In other words, the paste or pulp may adhere to the internal container surfaces and may require the application of a force by the apparatus to be fully dispensed from the container.

The housing receives the container 180 of plant based milk concentrate. In this embodiment, the upper section 130 receives the container 180 through an aperture 131. The aperture 131 may be an opening that is always open. Alternatively, the aperture 131 may be adapted to open or close when desired by a user, such that the container 180 can be inserted into the upper section 130 when the aperture 131 is open. When inside the housing, the container may be opened by an opening mechanism 132 of the apparatus 100. The opening mechanism 132 is located within the upper section 130 of the housing adjacent a receiving section 133 that receives the container 180. The nature of the opening mechanism 132 is chosen to reflect the type of container 180 in which the plant based milk concentrate is contained. For example, the container 180 may be frangible or have a frangible section and the opening mechanism 132 may assert a force to cause the frangible container or frangible section of the container 180 to break or fracture to cause the plant based milk concentrate to be dispensed. The opening mechanism 132 may be moveable within the housing. The opening mechanism 132 may comprise a sharpened section or scissors or a scissors like implement, which is adapted to cut through a material of the container 180 to release the plant based milk concentrate.

In the embodiment shown in FIG. 1, the container 180 is a stick pouch formed from a thin paper based and/or polymer based material which can be cut open. The opening mechanism 132 comprises scissors that may cut through the material of the container 180 when it is within the receiving section 133. For example, the opening mechanism 132 may cut the bottom off the container 180 to cause the plant based milk concentrate to dispense through the opening bottom of the container 180. A powder material may flow more easily than other substances from the opened container 180 due to the force of gravity. Alternatively, the apparatus 100 may comprise means for applying a force to dispense the plant based milk concentrate from the container 180. The apparatus 100 may comprise a receptacle, within or adjacent to the housing, which is adapted to receive a used container 180 after the plant based milk concentrate has been dispensed. Additionally or alternatively, the receptacle may receive a section of the container 180 which has been removed from the body of the container 180 by the opening mechanism 132. For example, the receptacle may receive the bottom part of the container 180 that has been removed from the container 180 by the opening mechanism 132 to release the plant based milk concentrate, with the plant based milk concentrate being dispensed into a location other than the receptacle, preferably a bottle.

A section of the housing of the apparatus 100 holds a motor and/or a pump. In this embodiment, the motor and/or pump are held in the main body 120 of the housing. In alternative embodiments, one or both of the motor and pump could be housed within the apparatus 100 in a location other than the main body 120. For example, one or both of a motor and a pump may be located in the base 110. Alternatively or additionally, one or both of a pump and a motor may be located in the upper section 130 of the housing. The opening mechanism 132 may be powered by the motor.

The apparatus 100 comprises a bottle receiving area 140, which is sized to receive a bottle 160. The bottle 160 may be formed from any desired material, such as polymer or plastic, metal, glass or a combination of any of these. The bottle 160 may be a glass bottle. The bottle 160 may be insertable into the apparatus 100 by a user. In this embodiment, the bottle 160 is received by the upper section 130 of the housing. The housing may have a retention means for retaining the bottle 160 is a fixed relationship relative to the housing. For example, the bottle 160 may be inserted into the housing and twisted by the user to engage the retention means of the housing. Alternatively or additionally, the retention means may have a gripping means to grip a surface of the bottle.

In this embodiment, the bottle 160 is filled with a desired amount of water to be mixed with the plant based milk concentrate in container 180. The filled bottle 160 can be inserted into the bottle receiving area 140. The filled bottle 160 can then be retained by the retention means relative to the housing. The water in the bottle 160 may be provided at a desired temperature. The desired temperature may be at or below room temperature, preferably the water is 5° C. to 25° C., more preferably 10° C. to 20° C. In this example, and in other examples, the term bottle has been used. Vessels other than bottles may be used in place of the bottle 160. For example, the vessel may be a bag, canister, flask, carton, jug, pot, tub or other vessel suitable for holding and/or storing a plant based milk concentrate.

According to alternative embodiments, the apparatus 100 may include a water tank. The water tank may be refilled with a liquid, preferably water. The water tank may include an opening which permits water to be dispensed from an external source into the water tank. The water tank may be fluidically connected to bottle 160 by one or more conduits. The water may be pumped from the water tank through the one or more conduits to the bottle 160 by the pump. The water may be provided at a desired temperature. The desired temperature may be at or below room temperature, preferably the water is 5° C. to 25° C., more preferably 10° C. to 20° C.

When the container 180 is placed into the aperture 131 and received in the receiving section 133 the opening mechanism 132 acts to open the container 180. The plant based milk concentrate is dispensed from the container 180 once the container is opened. The plant based milk concentrate may be dispensed directly into the bottle 160 through an opening 161 in the bottle 160. The plant based milk may drop into the bottle 160. According to other possible embodiments the plant based milk concentrate is dispensed indirectly into the bottle 160. For example, the plant based milk concentrate may be dispensed from the container 180 into the housing and then from the housing into the bottle 160. The concentrate may drop directly from the container 180 into the bottle 160. The concentrate may drop directly from the container 180 into the bottle 160. Alternatively, the concentrate may drop/dispense into the housing from the container 180 and then drop/dispense from the housing into the bottle 160.

When the bottle 160 is positioned correctly within the bottle receiving area 140 a mixing head 150 is positioned within the opening 161 of the bottle 160. FIG. 3 shows an example of a mixing head 150. As shown in FIG. 1, the mixing head 150 is at least partially located within the upper section 130. The mixing head 150 may be fully or substantially located within the upper section 130 when no bottle is in the bottle receiving area 140. When the bottle 160 is in the bottle receiving area 140, a mixing head movement means may move the mixing head 150 from a first position substantially located within the upper section 130 to a second position where the mixing head 150 extends into the bottle 160 through the opening 161. The movement means may include a handle which can be pulled or pushed by a user to move the mixing head 150 between the first and second positions. The movement means may comprise a mechanical mechanism to move the mixing head 150 between the first and second positions. The movement means may comprise an electronically controlled mechanism to move the mixing head 150 between the first and second positions. The movement means may be powered by the motor of the apparatus. The mixing head 150 is adapted to mix the plant based milk concentrate and water within the bottle 160.

The mixing head 150 comprises at least a mixing blade 151 and stator screen 152. The mixing head 150 may function as a high speed blender to blend the concentrate with the water to form a smooth plant based milk. The mixing blade 151 is preferably formed of stainless steel. The stator screen may be ring shaped and/or has a circular cross section. The stator screen 152 surrounds the mixing blade 151, such that the mixing blade 151 is adapted to rotate within the stator screen 152. The stator screen 152 has a plurality of apertures 155. The stator screen 152 has an annular shape and the apertures 155 are positioned around the circumference of the annular shape. The apertures 155 are preferably positioned in one or more rows of apertures around the circumference of the stator screen 152, The apertures 155 in the stator screen 152 may be offset relative to one another in their rows. The apertures in the stator screen 152 are preferably sized less than 2 mm in diameter, more preferably 1.0 mm to 1.5 mm in diameter. FIG. 4 shows examples of three possible stator screens 152A, 152B, 152C with varying sizes of apertures 155A, 155B, 155C.

The mixing blade 151 may comprise a plurality of individual blade arms 153 extending from a central axis. At least one blade surface 154 of the mixing blade 151 is located proximal to the stator screen 152. Each blade arm 153 of the mixing blade 151 may comprise a blade surface 154 that is proximal to the stator screen 152 in use. During a mixing process the blade arms 153 of the mixing blade 151 rotate about the central axis. A small gap is located between the mixing blade surface(s) 154 and an inner surface of the stator screen 152. The gap between the at least one blade surface 154 of the mixing blade 151 and the stator screen 152 may be less than 1 mm. The rotation of the mixing blade 151 within the stator screen 152 creates shear. Rotation of the mixing blade 151 within the stator screen 152 when the mixing head 150 is located within a liquid in the bottle/container 160 may create a vortex in the liquid.

In use, the bottle 160 is placed into the bottle receiving area 140. The bottle 160 may be prefilled with a liquid, such as water, by a user prior to placement into the bottle receiving area 140. The bottle 160 is preferably retained in a fixed relationship with the housing by a retention means, such as discussed above. In this position, the opening 161 of the bottle 160 may be adjacent and/or partially within and/or connected to the upper section 130 of the housing. With the bottle in place, a container 180 containing a plant based milk concentrate is placed in to the aperture 131 of the upper section 130. The container 160 will then be located within the receiving section 133. The opening mechanism 132 acts to open the container 160 through a suitable means. The plant based milk concentrate will be dispensed through the opening in the container 160 created by the opening mechanism and into the bottle 160 through the opening 161. The mixing head 150 will be located within the bottle 160 through its opening 161. The mixing head 150 may be moved by a movement means from a first position outside the bottle 160 to a second position at least partially within the bottle 160. The mixing blade 151 of the mixing head 150 rotates at high speed within the stator screen 152 to create a shear which mixes the plant based milk concentrate and water within the bottle 160 to create a plant based milk. When the mixing has been completed, if necessary, the mixing head 150 is removed from the bottle 160 via the movement means, and the bottle 160 can be removed from the apparatus by a user.

The motor is adapted to provide a force to rotate the mixing blade 151. According to this embodiment, the mixing blade 151 rotates at a high speed at about 2000 revolutions per minute (rpm). The mixing blade could be rotated at speeds of at least 2000 rpm, at least 2500 rpm, at least 3000 rpm, at least 3500 rpm, or at least 4000 rpm. The high speed rotation of the mixing blade 151 within the stator screen 152 produces a high shear vortex mixing profile. In other words, the concentrate will be pulled into the liquid and forced together through the apertures in the stator screen 152. This process reduces particle size of the plant based milk concentrate in the water mixture and once the mixing head 150 has operated in this manner for a suitable length of time a stable emulsion of concentrate mixed into the water to form a plant based milk is the result. The operation of the mixing head 150 may also create a plant based milk with a smooth consistency and no lumps of concentrate.

The high speed rotating motion of the mixing blade 151 may be powered or rotated by the motor. The mixing head 150 may be removable form the apparatus 100 for cleaning after use. The mixing head components (mixing blade 151 and stator screen 152) may also be individually removable form the apparatus 10 for cleaning or replacement.

The size of the container 180 and amount of plant based milk concentrate therein will determine the amount of water to be mixed with the concentrate and thus the amount of plant based milk produced. According to embodiments, the container 180 may contain 10 to 100 grams of plant based milk concentrate. Around 55-60 grams of plant based milk concentrate may be sufficient to mix with water and produce about 750 ml of plant based milk. According to preferred embodiments, the bottle 160 is adapted to hold 500 ml to 1 litre of plant based milk produced by the apparatus 100.

The bottle 160 may comprise a timing mechanism, not shown. The timing mechanism is adapted to be manipulated by the apparatus 100 or a user such that the date and/or time of the production of a plant based milk by the apparatus 100 will be displayed by the timing mechanism on the bottle 160. The timing mechanism can be used by a user to determine how long ago a plant based milk in the bottle 160 was produced to assist in determining if the plant based milk remains potable. A plant based milk created from a concentrate mixed with water may be storable in a refrigerator for several days, for example about 3 days, before any noticeable effect on the quality of the milk or any spoiling. The timing mechanism may be automatically altered by the apparatus 100 when the plant based milk is being produced. Alternatively, the user may manipulate the timing mechanism, such as by rotating one or more dials of the timing mechanism. The timing mechanism may be part of or attached to a lid of the bottle 160.

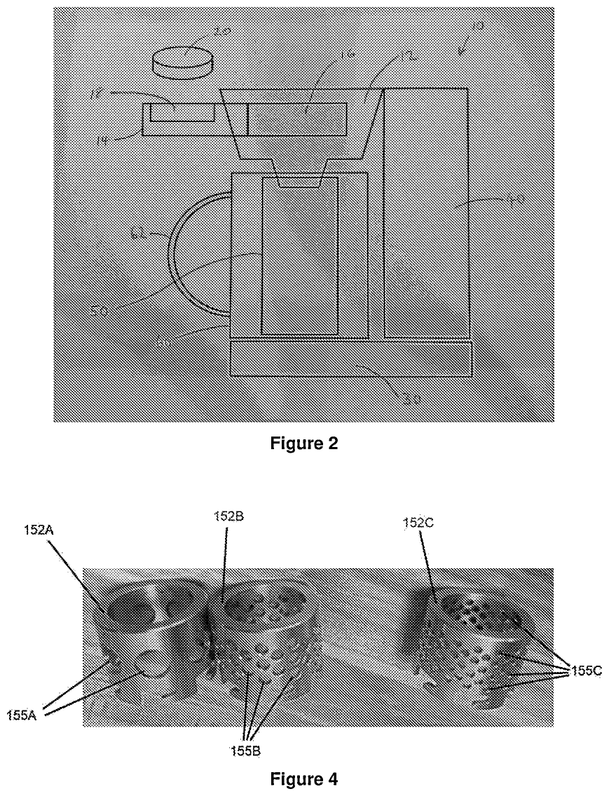

FIG. 2 depicts an alternative system for forming a plant based milk comprising an apparatus 10. The apparatus 10 has a housing that includes a pour system 12. The pour system 12 being part of a housing of the apparatus 10. The apparatus 12 includes a tray 14, the tray 14 is releasably held within the pour system 12 in a receiving section 16. The tray 14 can be extended outwardly of the housing or pour system 14 to an extended position, as shown in FIG. 2. The tray 14 has a recess 18 adapted to receive a container 20. The container 20 contains a plant based milk concentrate. In this embodiment, the container 20 holds a plant based milk concentrate. The container 20 is a capsule containing the concentrate. The container 20 may be a sachet.

The plant based milk concentrate, of any embodiment discussed herein, may be any suitably concentrated plant based substance which will form a milk when mixed with water. Milk, in this context, includes a food product produced from a plant based source that resembles and is used similarly to cow's milk. It is generally preferred that the concentrate is a powder or paste. The powder is a dry dehydrated plant based particulate material. Alternatively, the concentrate could be a pulp or paste material or any other plant based concentrate substance.

A section of the housing of the apparatus 10 holds a motor and/or a pump. In this embodiment, the motor and pump are both held at a lower section 30 of the housing. According to other embodiments, one or both of the motor and/or pump could be located in the apparatus of housing of the apparatus at a position other than the lower section. For example, one or both of the motor and pump may be located in or adjacent to the pour system 12. Alternatively or additionally, one or both of the motor and pump may be located adjacent to or in the same structure as the water tank. The apparatus 10 includes a water tank 40. The water tank may be refilled with a liquid, preferably water. The water tank 40 may include an opening which permits water to be dispensed into the water tank 40. The water tank 40 is fluidically connected to the pour system 12 by one or more conduits. The water may be pumped from the water tank 40 to the pour system 12 through the one or more conduits by the pump. The water will be delivered via the pour system 12 into a mixing container 50. The water is provided at or below room temperature, preferably the water is 5° C. to 25° C., more preferably 10° C. to 20° C.

Once a container 20 is placed in the recess 18, the tray 14 is retracted into the housing, either manually or automatically, preferably into the pour system 12. The apparatus may determine when a container 20 has been received within the housing. When a sealed container 20 is within the housing, a blade or point will pierce or slice the container to create an opening in the container from which the concentrate may be dispensed into the pour system 12. After the concentrate has been dispensed from the container, it may be held in a container detainment section for later disposal or may be otherwise removed from the housing for disposal. The concentrate may leave the container via gravity or may be mechanically or otherwise removed from the container. For example, a force may be applied by the apparatus to remove the concentrate from the container. Where the concentrate leaves the container via gravity, it may be preferable that the concentrate is a powder or other easily flowable substance in order to be fully dispensed. The concentrate is dispensed from the pour system 12 into the mixing container 50, where it meets the water.

The mixing container 50 is part of a mixer system that is adapted to mix the plant based milk concentrate with the water. The mixer system functions as a blender to blend the concentrate with the water to form a smooth plant based milk. The mixing container is preferably formed of stainless steel. The mixer comprises a mixing blade, which may be sharp. The mixing blade is preferably formed of stainless steel. A stator screen surrounds the mixing blade, such that the mixing blade is adapted to rotate within the stator screen. The stator screen has a plurality of apertures. The stator screen has an annular shape and the apertures are positioned around the circumference of the annular shape. The apertures are preferably positioned in a plurality of adjacent rows of apertures around the circumference of the stator screen, The apertures in the stator screen are preferably sized less than 2 mm in diameter, more preferably 1.0 mm to 1.5 mm in diameter.

The mixing blade and stator screen together form a mixing head and are located within the mixing container. The mixing blade may comprise a plurality of individual blade arms extending from a central axis. At least one blade surface of the mixing blade is located proximal to the stator screen. Each blade arm of the mixing blade may comprise a blade surface that is proximal to the stator screen in use. During a mixing process the blade arms of the mixing blade rotate about the central axis. A small gap is located between the mixing blade surface(s) and an inner surface of the stator screen. The gap between the at least one blade surface and the stator screen may be less than 1 mm. The rotation of the mixing blade within the stator screen creates shear. The mixing head, mixing blade and/or stator screen used in the embodiment of FIG. 2 may be the same as the mixing head 150 shown and/or described in relation to FIG. 1, 3 or 4.

The motor is adapted to provide the force to rotate the mixing blade. According to this embodiment, the mixing blade rotates at a high speed at about 2000 revolutions per minute (rpm). The mixing blade could be rotated at speeds of at least 2000 rpm, at least 2500 rpm, at least 3000 rpm, at least 3500 rpm, or at least 4000 rpm. The high speed rotation of the mixing blade within the stator screen produces a high shear vortex mixing profile. In other words, the concentrate will be pulled into the liquid and forced through the apertures in the stator screen. This reduces particle size of the concentrate in the water mixture and once the mixing head has operated in this manner for a suitable length of time a stable emulsion of concentrate mixed into the water to form a plant based milk is the result. The operation of the mixing head may also create a plant based milk with a smooth consistency and no lumps of concentrate.

A milk container 60 is arranged outside of the mixing container 50. The milk container 60 may be placed by a user into a receiving area of the apparatus 10 from which it is removable by the user. The milk container 60 may be held in position or locked onto the apparatus 10 while mixing of the concentrate and water takes place. Once a plant based milk has been formed by mixing the concentrate and water, the plant based milk is dispensed from the mixing container into the milk container. A filter may be provided between the mixing container and the milk container to yet further reduce possibility of particles or lumps in the plant based milk end product. By using cold or room temperature water, the present invention may provide a plant based milk which is ready to drink or use directly after mixing has occurred. The milk container 60 may have a handle 62 to assist in removal from the apparatus 10.

In the embodiment shown in FIG. 2, the mixing container 50 is located within the milk container 60 during use. According to other embodiments, the mixing container 50 may be positioned elsewhere on or in the apparatus 10 with respect to the milk container 60. For example, the mixing container 50 may be located within the pour system 12 above the milk container 60. In that case, once the plant based milk is produced by the apparatus it may be dispensed into the milk container 60 through an upper opening thereof. According to other embodiments, the apparatus 10 does not comprise a separate mixing container 50 and the mixing head mixes the concentrate and water within the milk container itself. In that scenario, the mixing head may be lowered into the mixing container and later removed therefrom after production of the plant based milk or alternatively the milk container 60 may be connected to the apparatus in a manner that the mixing head protrudes into an opening of the milk container.

The mixing container 50 is removable from the apparatus 10 for cleaning after use. The mixing head components (mixing blade and stator screen) may also be removable form the apparatus 10 for cleaning or replacement. In the embodiment shown in FIG. 2, the mixing container 50 is located within the milk container 60 during use. According to other embodiments, the mixing container 50 may be positioned elsewhere on or in the apparatus 10 with respect to the milk container 60. For example, the mixing container 50 may be located within the pour system 12 above the milk container 60. In that case, once the plant based milk is produced by the apparatus it may be dispensed into the milk container 60 through an upper opening thereof. According to other embodiments, the apparatus 10 does not comprise a separate mixing container 50 and the mixing head mixes the concentrate and water within the milk container itself. In that scenario, the mixing head may be lowered into the mixing container and later removed therefrom after production of the plant based milk or alternatively the milk container 60 may be connected to the apparatus in a manner that the mixing head protrudes into an opening of the milk container.

The size of the container 20 and amount of concentrate therein will determine the amount of water to be mixed with the concentrate and thus the amount of plant based milk produced. According to embodiments, the container may contain 20 to 100 grams of plant based milk concentrate. Around 55-60 grams of plant based milk concentrate may be sufficient to mix with water and produce about 750 ml of plant based milk. According to preferred embodiments, the milk container 60 is adapted to hold 500 ml to 1 litre of plant based milk produced by the apparatus 10.

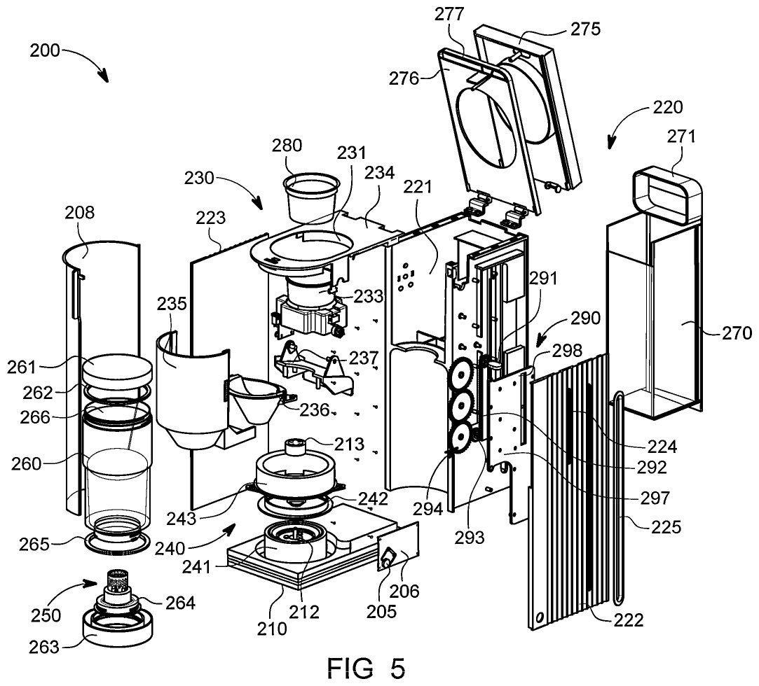

FIGS. 5 to 8 provide another embodiment for producing a plant based milk. An apparatus 200, shown in FIG. 5 in an exploded form, comprises a base 210, a main body 220 and upper section 230. The upper section 230 may be connected to and/or formed at least partly unitarily with the main body 220. The base 210 may be connected to and/or formed at least partly unitarily with the main body 220. The upper section 230 may be housed within the main body 220, may be adjacent to the main body 220, or may be partly within and partly adjacent to the main body 220.

As shown in FIG. 5, the main body 220 comprises a central housing 221. The upper section 230 is partly contained within the central housing 221. A top part 234 of the upper section 230 partly covers the upper end of the central housing 221. The top part 234 comprises an aperture 231. In the embodiment shown the aperture 231 is circular, but according to other possible embodiments may be any desired shape.

The apparatus 200 includes a lid 275. The lid 275 according to this embodiment is pivotally hinged to the central housing 221. The lid 275 optionally includes a lid cover 276 over the lower surface of the lid 275. The lid 275 may comprise a lid handle 277. The lid 275 may be opened by a user to reveal the central housing 221 and/or upper section 230 beneath.

The upper section 230 includes a container receiver 233. The container receiver 233 may be shaped and/or sized to receive a container 280. The container 280 may be a sachet, a pod or another other suitable container of plant based milk concentrate. Optionally, the upper section 230 may comprise an opening mechanism which is configures to open the container 280. An opening mechanism may be any type of opening mechanism that opens the container 280 to allow its contents to be dispensed, for example as shown and/or described in relation to FIG. 1. According to the embodiment shown in FIG. 5, the apparatus 200 does not comprise an opening mechanism. In the embodiment shown, the user may manually open an upper end of the container 280, in one example such as by pulling away a thin film or metallic sheet covering or other type of covering over the opening of the container 280. According to embodiments the container 280 may have a lid that is removed to enable dispensing of the contents. The container 280 may be opened by the user after it has been placed into the container receiver 233. Opening the container 280 within the apparatus 200 may mean that any spillage of the contents of the container 280, such as plant based milk concentrate, may be reduced or restricted to within the apparatus 200 where it may still be used.

As shown in FIG. 5, the container receiver 233 is pivotable within the apparatus 200. The container receiver 233 may include a protrusion on each side that pivots within a corresponding hole, groove or indentation within the upper section 230 and/or central housing 221. Alternatively, the protrusion(s) may be on the upper section 230 and/or central housing 221 and the corresponding hole, groove or indentation may be on the container receiver 233. In the embodiment shown, the container receiver 233 pivotally connects to receiver support 237. Receiver support 237 includes protrusions that engage with corresponding indentations or holes in the container receiver 233. The receiver support 237 remains stationary during a pivoting movement of the container receiver 233 and the container receiver 233 may pivot relative to the receiver support 237. The mechanism 290 for causing the container to pivot is shown in FIG. 5 is discussed further below.

The upper section 230 includes a front wall 235. The lower end of the front wall 235 is partly inwardly tapered. The front wall 235 as shown in FIG. 5 is outwardly curved. Adjacent to the lower end of the front wall 235 is a funnel 236. The funnel 236 has an open upper end that tapers inwardly towards an open lower end. The funnel 236 is configured to receive the contents of the container, typically a plant based milk concentrate such as a powder or paste or concentrated liquid, and to direct it into a bottle 260 or other container/vessel. The front wall 235 is located to the front of the pivotable container receiver 233. The funnel 236 is located below the container receiver 233.

Mechanism 290 is provided to enable the container receiver 233 to pivot. The mechanism 290 includes board 297 which is affixed within the apparatus 200 to the central housing 221. The board 297 includes a vertical slot 298. The mechanism 290 includes lever 291 which is vertically moveable within the slot 298. The lever 291 is connected to rack 292. The teeth on rack 292 engage with teeth on gear 293. The teeth on gear 293 also engage with a larger gear 294. In the embodiment shown in FIG. 5, there are three larger gears 294, the gears 294 are aligned vertically and each gear 294 engages with each adjacent gear 294. According to the present invention any arrangement of gears may be possible. The upper gear 294 is configured to cause the pivoting motion of the container receiver 233. The gears 293, 294 may be rotationally mounted to the central housing 221. The upper gear 294 may be rotationally mounted to the container receiver 233 and/or to receiver support 237.

The mechanism 290 functions such that when the lever is pressed downwards by a user the teeth on the rack 292 and gears 293, 294 engage with one another to convert the vertical movement of the lever to rotational movement of the upper gear 294 and rotation of the container receiver 233. Other mechanisms may be provided in place of mechanism 290 that may cause the container receiver 233 to rotate and/or to cause a container 280 to dispense its contents.

The main body 220 includes outer walls 222, 223 which are positioned on either side of the apparatus respectively. The outer walls 222, 223 are positioned outwardly of the central housing 221 and mechanism 290. The outer wall 222 on the same side of the central housing 221 as the mechanism 290 includes a slot 224. When the apparatus 200 is constructed together the slot 224 is aligned with the slot 298 in board 297. The lever 291 is positioned outside the outer wall 222 and is moveable within slot 224. The lever 291 is visible and actuatable by a user while the other elements of the mechanism 290 may be hidden by the side wall 222 and may not be visible to the user.

The apparatus 200 includes a receptacle 270. The receptacle 270 is a container that is positioned to the rear of the main body 220. The receptacle 270 is configured to contain used containers 280 after their contents has been dispensed into the apparatus 200. At least one of the side walls of the receptacle 270 may be formed of a transparent or translucent material. The rear wall of the receptacle 270 may be non-transparent. The receptacle 270 may include a handle 271 to assist a user to remove the receptacle 270 from the main body 220. The side wall 222 may include a window 225. The transparent/translucent side wall(s) of the receptacle and the window 225 may permit a user to view the contents of the receptacle 270 and to determine how full the receptacle 270 is and/or whether the receptacle requires emptying.

The base 210 is located beneath the main body 220. The base includes bottle seat 240 onto which a bottle 260 may be placed. The bottle seat 240 may be configured to securely hold the bottle 260 in place. The bottle seat 240 includes an inner seat 241. The inner seat 241 directly engages with the lower surface of the bottle 260. The inner seat 241 may be formed unitarily with the base 210. A seal 242 may be positioned around the inner seat 241. An outer seat wall 243 is positioned surrounding the inner seat 241. The outer seat wall 243 is configured such that when the seat 240 receives a bottle 260 the lower part of the bottle will be located within the outer seat wall 243. An aperture within the outer seat wall 243 may be sized such that is at least the same size in diameter as the diameter of the bottle 260 or slightly larger than the diameter of the bottle 260. Optionally, the bottle 260 may be locked in position on the bottle seat 240 when the apparatus is in use.

A apparatus 200 comprises a motor (not shown). In the embodiment of FIG. 5, the motor is housed within the base 210. A rotor shaft 212 of the motor protrudes from the base centrally within the inner seat 241. A connector 213 is rotationally connected to the base 210. The rotor shaft 212 is configured to rotate the connector 213. The rotor shaft 212 may rotate the connector at a speed of at least 2000 revolutions per minute (rpm). The rotor shaft 212 may be rotated at a speed of at least 2000 rpm, at least 2500 rpm, at least 3000 rpm, at least 3500 rpm, or at least 4000 rpm.

FIG. 5 shows an embodiment of a bottle 260 that is compatible with the apparatus 200. The bottle 260 is sized and shaped to be insertable into the apparatus 200 and to be seated in the seat 240. When placed in the apparatus 200, the top of the bottle 260 is located beneath the funnel 236 and tapered lower end of the front wall 235. Although the term bottle has been used in the present description, it is understood that the present disclosure is broad enough to encompass any type of vessel or container. For example, the vessel may be a flask, a bottle, a cup, or a mug.

The bottle 260 includes a lid 261 that removably attaches to the upper end of the bottle 260. Beneath the lid 261, the bottle 260 has an opening 266. The lid 261 may be scalably attached to the body of the bottle 260. For example, the bottle in FIG. 5 includes an O-ring 262 to seal the lid 261 to the bottle 260. The bottle 260 may be formed from any suitable material. For example, the bottle 260 may be formed of a polymeric material or glass, the bottle 260 may be formed from PET. The bottle 260 may be transparent or translucent or may be partly transparent or translucent.

The lower end of the bottle 260 includes a cap 263. The cap 263 is removably attachable to the bottle 260. The cap 263 may be sealably attached to the body of the bottle 260. For example, the bottle 260 in FIG. 5 includes an O-ring 265 to seal the cap 263 to the bottle 260. The cap 263 includes an insert 264. The insert 264 may be removably attachable to the cap 263. According to other possible embodiments, the insert 264 may be unitarily formed with and unattachable from the cap 263, in these embodiments the following discussion of features of the insert 264 may be considered as referencing the cap 263. The cap 263 may have a central hole and the insert 264 when attached to the cap 263 may cover the hole. The insert 264 may be sealably attachable to the cap. The lower end of the insert 264 may have a rotatable connector which is configured to engage with the connector 213 of the base 210 when the bottle 260 is seated in the apparatus 200.

As shown in FIG. 5, a mixing head 250 is attachable to the insert 264. The mixing head 250 may be attached to the insert 264 or cap 263. The mixing head 250 may be similar to or the same as discussed herein with reference to any of FIGS. 1 to 4 or as otherwise described herein. The mixing head 250 includes a stator screen and a rotating blade. The stator screen may be removably attachable to the insert 264 and/or cap 263. Removal of the stator screen may facilitate easy cleaning of the mixing head 250 after use. The blade of the mixing head 250 may be connected to the rotatable connector of the insert 264. Thus, when the bottle 260 is positioned on the seat 240 and the connector 213 and rotatable connector of the insert 264 are engaged with one another, rotation of the rotor shaft 212 by the motor in turn causes a rotation of the mixing head 250. The mixing head 250 therefore spins at the same RPM speed as the rotor shaft.

As also shown in FIG. 5, the apparatus 200 includes a power switch 205 or button. The power switch 205 may be connected to internal circuitry 206 of the apparatus 200. The circuitry 206 may include a PCB. The circuitry 206 may control the functioning of the various powered elements of the apparatus. For example, the circuitry 206 may control the motor, including but not limited to, speed of rotation, duration of rotation and/or timing of starting and/or stopping of rotation. The power switch 205 may be housed within the main body 220 and/or may be user actuatable through a hole in the side wall 222. The apparatus may be connected to a source of power (not shown). According to embodiments, the apparatus may be battery powered or may include a rechargeable battery. A battery, where present, may be internally held within the base 210 or main body 220.

The apparatus optionally includes a door 208. The door may be hinged to the main body 220. The door may be formed from a transparent or translucent material.

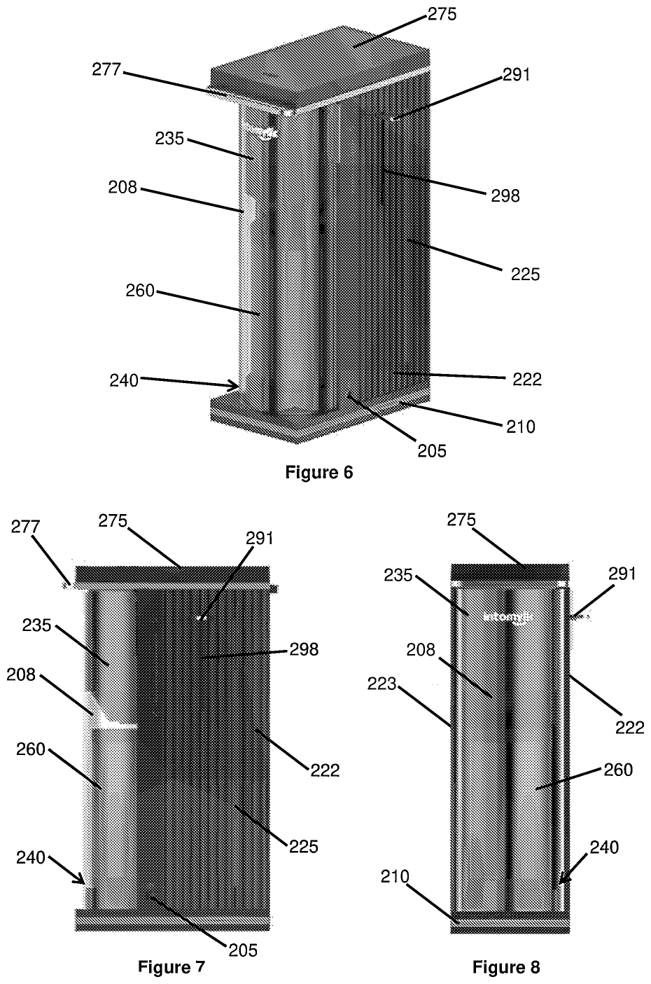

FIGS. 6-8 show the apparatus 200 when the elements shown in FIG. 5 are assembled and the bottle 260 is inserted into the apparatus 200 and seated on the seat 240.

The following description provides details of the manner in which the apparatus 200 may be utilised by a user to create a plant based milk from a concentrate and steps of a method of possible use of the apparatus 200. The bottle 260 may be assembled, if necessary, such that the mixing head 250 is within the body of the bottle 260. The lid 261 of the bottle 260 may be removed by the user so that the bottle opening 266 is available. The bottle 260 is filled with an amount of water. According to possible embodiments, the bottle 260 may be filled with water when it is inside the apparatus 200. For example, the apparatus 200 may include or be connected to a source a water. According to the embodiment shown, the bottle 260 is manually filled with water by the user prior to insertion into the apparatus. The door 208 is opened and the bottle 260 is inserted into the apparatus 200 and seated on the seat 240. Optionally, the door 208 may be closed.

The lid 275 of the apparatus 200 is opened. The container 280, containing a plant based milk concentrate, is inserted into the container receiver 233 through the aperture 231. The container 280 is opened to enable its contents to be dispensed. The container 280 may be opened by a user prior to insertion into the container receiver 233 after the container 280 has been inserted into the container receiver 233. According to other possible embodiments, the apparatus 200 may include a means for opening the container 280, such as a cutting implement, a piercing implement, an implement to peel a film form the container 280, or any other possible manner of opening the container 280. When the container 280 is within the container receiver 233 the lid 275 of the apparatus 200 may be closed.

The user turns on the power to the apparatus 200 by pressing the power switch 205. The power switch 205 may be turned on at any time prior to the lever 291 being actuated by the user. To cause the contents (plant based milk concentrate) of the container 280 to be dispensed the user pushes the lever 291 downwards. The lever 291 at a top position prior to being actuated by the user. When the lever is pushed the rack 292 moves linearly and causes a rotation of the gear 293 which in turn causes a rotation of the gears 294. The rotation of the upper gear 294 causes the container receiver 233 to be rotated and the contents of the container 280 to be gradually dispensed outwardly towards the front wall 235 and funnel 236. The front wall 235 directs the plant based milk concentrate into the funnel 236. The funnel 236 directs the concentrate into the opening 266 of the bottle 260. The container 280 is rotated until it has reached a final rotation orientation and/or all of the contents or the majority thereof have been dispensed. The plant based milk concentrate may be a powder or a flowable substance. The plant based milk concentrate may be a paste.

When plant based milk concentrate is within the water in the bottle the motor will initiate and cause the mixing head 250 to rotate at a desired speed. Rotation of the mixing blade within the stator screen of the mixing head 250 creates a vortex within the water. The plant based milk concentrate within the water is pulled into the mixing head by the vortex and is emulsified or mixed into the water to form a plant based milk. The mixing head 250 of this or any other embodiment here may also be termed as a shearing head. The mixing head 250 or shearing head may shear the concentrate within the water. The high velocity of the rotating blade within the stator shield may lead to the shearing of the concentrate. The motor may be a geared motor and/or may have a gradual increase and decrease in rotation speed. The motor may begin to rotate the mixing head 250 as soon as the lever is actuated by the user before at the same time as the contents of the container 280 are dispensed into the water in the bottle. The rotation of the mixing head 250 and creation of a vortex in the water prior to and/or at the time of the plant based milk concentrate being dispensed may assist in creating a smooth plant based milk. The speed of the mixing blade of the mixing head may 250 gradually increase as the contents of the container 280 is dispensed into the water. The mixing blade of the mixing head 250 may decrease in speed gradually at a time when the plant based milk concentrate has been fully mixed with the water.

After the contents of the container 280 have been dispensed and the container 280 is empty it is ejected by the apparatus 200 into the receptacle 270 for later disposal. The container 280 may be ejected into the receptacle 270 when the lever 291 is returned to its original position.

When the plant based milk has been formed by the apparatus 200 the user may open the door 208 and retrieve the bottle 260 which now contains a plant based milk. The user may replace the lid 261 on the bottle 260 if it is required to store some or all of the plant based milk for later use. When the plant based milk has been emptied from the bottle 260 the bottle 260 may be disassembled to be cleaned.

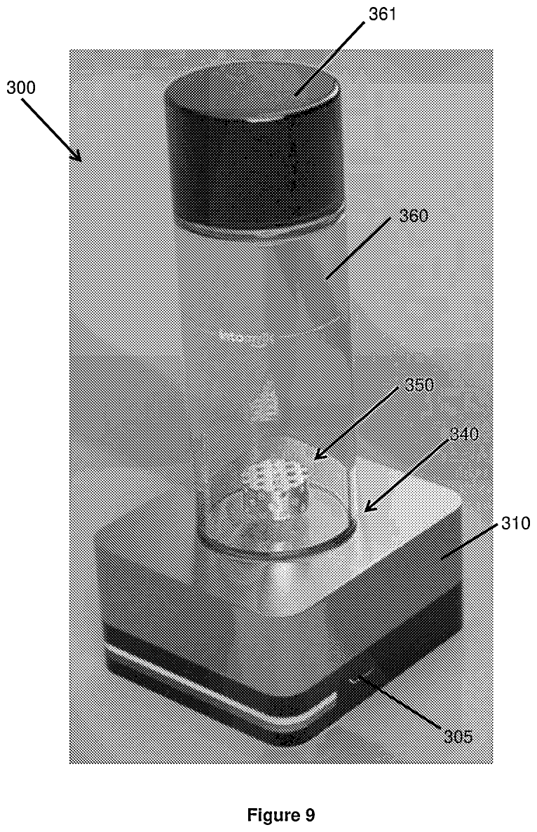

FIG. 9 shows a further embodiment of an apparatus 300 for forming a plant based milk. The apparatus 300 may be portable. The apparatus 300 is similar to that shown in FIG. 5 but elements such as the main body and upper section have been excluded in the embodiment of FIG. 9. The apparatus 300 comprises a base 310. The base 310 includes a bottle seat 340 for receiving a bottle 360. The bottle seat 340 may be the same as or similar to that described in relation to FIG. 5. The bottle seat 340 may receive and hold a bottle 360 in position. The bottle 360 may locked in position on the bottle seat 340 when the apparatus 300 is in use. The base 310 and/or bottle 360 may have a locking mechanism.

The bottle 360 includes a lid 361 that is removed to insert a water. The bottle 360 of the embodiment of FIG. 9 may be the same or similar to the bottle of FIG. 5. Mixing head 350, which may be of the type described or provided herein previously, is contained within the bottle 360.

A motor is housed within the base 310 (not shown). The motor is configured to rotate the blade of the mixing head 350 when the bottle 360 is seated on the base 310. The mixing blade of the mixing head 350 may be rotated by the motor in a manner as described above in relation to FIG. 5. The apparatus 300 may have a power switch 305. A source of power may be present within the base 310 or the base may be configured to connect to a source of power. The power source may be at least one battery or may be a rechargeable battery. Pressing the power switch may cause the mixing head 350 to operate when the bottle 360 is in position on the base 310. According to possible embodiments, the motor and mixing head 350 could be initiated by rotating the bottle 360 into position on the bottle seat 340 and/or may be initiated by a locking mechanism of the bottle 360 onto the base 310. When a mixing process of plant based milk concentrate with water in the bottle 360 has been completed the bottle 360 may be removed or may be unlocked and/or rotated off the bottle seat 340 and removed from the base 310.

As can be seen in FIG. 9, the apparatus 300 does not include a container receiver to receive a pod, a sachet or container of plant based milk concentrate. In this case, a plant based milk concentrate from a container may be manually added to the water in the bottle 360 when the lid 361 is removed. The plant based milk concentrate may be added to the water in the bottle 360 prior to the bottle 360 being seated on the base 310 or after the bottle 360 has been seated on the base 310.

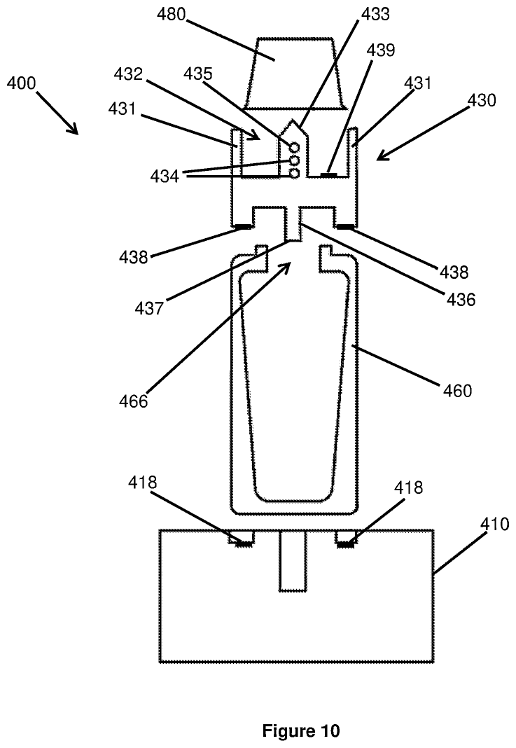

According to other embodiments, the apparatus 300 as shown in FIG. 9 may additionally include a means to receive a plant based milk container. For example, FIG. 10 shows an apparatus 400 similar to that shown in FIG. 9 but which also includes a container receiver 430 which is configured to receive container 480. The container 480 may be a sachet. The bottle 460 shown in FIG. 10 may be of the same type and have the same features as the bottles shown in FIG. 5 and/or FIG. 9. The base 410 may include an internal motor configured to cause a rotation of a mixing head within the bottle 460. The base 410 may include an internal power source, such as a rechargeable battery.

The container receiver 430 is sized and shaped to fit onto the bottle 460 and to cover the opening 466. The container receiver 430 may also function as a lid for the bottle 460 according to this embodiment. The container receiver 430 may be securely screwed into place on the bottle 460. The container receiver 430 may create a sealed connection with the bottle 460. The container receiver 430 includes at least one side wall 431 that spans a circumference of the receiver 430. Within the side wall(s) 431 is a space 432 into which the container 480 may be received. Centrally within the space 432 the bottle receiver 430 has a piercer 433. The piercer 433 is configured to pierce a wall or cover of the container 480 when the container 480 is pressed onto the container receiver 430. The container receiver 430 has a lower shaft 436. The container receiver 430 has an internal conduit that fluidically connects the piercer 433 to the lower shaft 436. The piercer 433 has at least one opening 434 in fluid communication with the internal conduit. The lower shaft 436 includes an opening 437 in fluid communication with the internal conduit.

The container receiver 430 is configured such that when a container 480 is in place in the space 432 and the piercer 433 has pierced the container the contents (plant based milk concentrate) will flow through the at least one opening 434 of the piercer 433 and down the internal conduit to the opening 437 of the shaft 436. The plant based milk concentrate will then be dispensed into the bottle to be mixed with water to form a plant based milk. According to other embodiments, the container receiver 430 may not include a shaft 436 and the plant based milk concentrate may instead be dispensed into the bottle through at least one opening in the base of the container receiver 430.

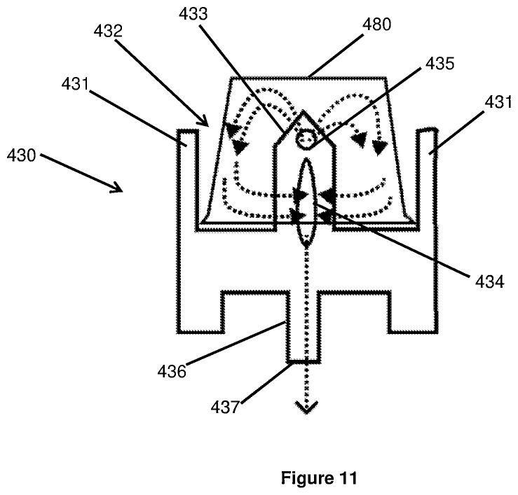

The container receiver 430 may include a vacuum suction mechanism which sucks the plant based milk concentrate from the container into the at least one opening 434 of the piercer 433. Such a suction mechanism is shown in FIG. 11, which is an enlarged view of the container receiver 430 with container 480. In the embodiment shown, the dispensing mechanism functions by having at least one outlet 435 which expels gas, such as air. The expelled gas may be pressurised. When the piercer 433 is within a container 480, the flow of air from the outlet 435 may circulate slightly in the container 480 and flow into the at least one opening 434 and along the internal conduit to opening 437. This flow of gas, when the container 480 is in place on the container receiver 430, will collect the plant based milk concentrate within the container and expel it towards the opening 437.

Optionally, the container receiver 430 may include a sensor 439 as shown in FIG. 10. The sensor 439 may detect when a container 480 is in place on the container receiver 430. The sensor 439 may detect the presence of the container 480 through touch, proximity or by detecting an identifier of the container 480. When the sensor 439 has detected a container 480 it may trigger the vacuum suction mechanism to dispense the plant based milk concentrate from the container 480. Alternatively, there may be a user actuated button or other manner to initiate dispensing of the plant based milk concentrate into the bottle 480.

The container receiver 430 may include an internal power source, such as a rechargeable battery. The internal power source may power the vacuum suction mechanism or other dispensing mechanism that may be in use. In the embodiment shown in FIG. 10, the container receiver 430 includes terminals 438. The terminals 438 may dock with an connect with corresponding terminals 418 of the base 410. Connecting the terminals 438 with terminals 418 may recharge the battery of the container receiver 430.

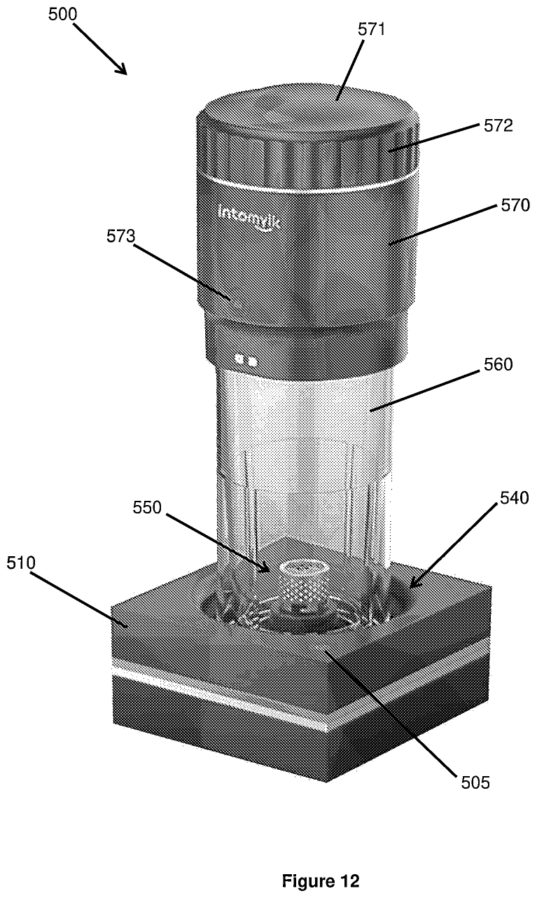

FIG. 12 shows a further embodiment of an apparatus 500 for forming a plant based milk from a concentrate. The apparatus 500 may be portable. In other words, the apparatus 500 may be of a size and weight which renders it suitable to be easily carried in a bag, taken on travels, or easily stored away. To be portable the apparatus is not bulky. The portable apparatus 500 may be suitable to be carried by a user who is travelling. The apparatus shown in FIGS. 9 to 12 and/or 13 to 17 may also be a portable apparatus or part of a portable apparatus.

The apparatus 500 includes a base 510. The base 510 may be substantially square in horizontal cross section. The base 540 includes a seat 540 configured to receive bottle 560. The seat 540 may be sized to receive the lower end of the bottle 560. The apparatus 500 may include a docking mechanism by which the bottle 560 is received by the seat 540. The bottle 560 may locked in position on the bottle seat 540 when the apparatus 500 is in use. The base 510 and/or bottle 560 may have a locking mechanism. The apparatus 500 may have a locking mechanism by which the bottle 560 may be releasably connected to the seat 540. For example, the lower end of the bottle 560 and/or the sides of the seat 540 on the base 510 may be threaded such that the bottle 560 can be rotated or twisted into a releasable locking engagement with the base 510. Other methods of releasably connecting the bottle 560 to the base 510 are also possible, for example there may be a clip mechanism which connects the two together by a surface on the bottle 560 engaging with a surface within the seat 540 and optionally a user may press a button or switch to thereafter release the bottle 560. Any other suitable connection mechanism is also possible within the scope of the present disclosure and the scope is not limited by the connection mechanisms described above.

A motor is housed within the base 510 (not shown). The motor is configured to rotate the blade of the mixing head 550 when the bottle 560 is seated on the base 510. The mixing blade of the mixing head 550 may be rotated by the motor in a manner as described above in relation to FIG. 5. The apparatus 500 may have a power switch 505. The apparatus 500 may be battery powered. A source of power may be present within the base 510 or the base may be configured to connect to a source of power. The power source may be at least one battery or may be a rechargeable battery. Having an internal source of power, such as at least one battery or a rechargeable battery, is preferable where the apparatus 500 is portable. The apparatus 500 or base thereof may comprise a connection port, such as a USB port (not shown). The battery (or batteries) of the apparatus 500 may be charged by connecting the connection port to a power outlet via a suitable cable. Pressing the power switch 505 may cause the mixing head 550 to operate when the bottle 560 is in position on the base 510. According to possible embodiments, the motor and mixing head 550 could be initiated by rotating the bottle 560 into position on the bottle seat 540 and/or may be initiated by a locking mechanism of the bottle 560 onto the base 510. When a mixing process of plant based milk concentrate with water in the bottle 560 has been completed the bottle 560 may be removed or may be unlocked and/or rotated off the bottle seat 540 and removed from the base 510.

According to embodiments, the bottle 560 is formed from a transparent material and/or at least partially transparent. The bottle 560 is formed from a translucent material and/or at least partially translucent. The bottle 560 may be formed from any one or more of glass, metal, stainless steel, plastic, polymer, polyethylene and/or PET (polyethylene terephthalate). In the embodiment shown in FIG. 12, the bottle is formed from PET.

FIG. 12 shows a cap 570 on the bottle 560. The bottle cap 570 may in some embodiments simply provide a closure over an opening of the bottle 560. The bottle cap 570 may be removably attached to the bottle 560. The bottle 560 and/or lid 570 may include a thread such that they can be screwed into engagement with one another. The bottle cap 570 may be removed from the bottle 560 in order to fill the bottle 560 with a liquid, such as water, and/or a concentrate. The bottle cap 570 may be configured to receive a plant based milk concentrate. The plant based milk concentrate received by the bottle cap 570 may be within a container. The bottle cap 570 may receive the container. A part of the cap 570 may be openable to reveal an internal cavity which is configured to receive the container. The part of the cap 570 may be openable by pressing switch 573. For example, the top 571 of the bottle cap 570 may be lifted or displaced to reveal an internal cavity of the cap 570. The bottle cap 570 includes a grip 572. The grip 572 may be held by a user to rotate the cap 570 into engagement with the bottle 560. The grip 572 may be held and rotated by a user to displace the top 571 from the cap 570. The grip 572 may be pulled relative to the cap 570 to displace the top 571. An internal cavity of the cap 570 may be configured to receive a container of plant based milk concentrate. When an internal cavity of the cap 570 has been revealed, a container of plant based milk concentrate may be inserted into the cap 570. The container may be opened within the cap 570 in order to dispense the concentrate into the bottle. The cap 570 may include an opener that is configured to open the container when inside the cap 570. The opener may pierce the container. Opening the container within the cap 570 may cause the concentrate to be dispensed into the bottle. The concentrate may dispense into the bottle at least partially through the force of gravity. The concentrate may be a flowable product. For example, the concentrate may be a concentrated liquid, the concentrate may be a paste and/or the concentrate may be a powder.

According to possible embodiments, the cap 570 may require a source of power to dispense the contents of the container and/or to open the container. The cap 570 may have an internal power source, such as one or more batteries or a rechargeable battery. The cap 570 may include switch 573 to initiate opening of a container inserted into the cap 570 and/or to dispense a concentrate from a container within the cap 570 into the bottle. The cap 570 may comprise an opening mechanism. The switch 573 may initiate the opening mechanism. The cap 570 may comprise a dispensing mechanism. The switch 573 may initiate the dispensing mechanism. The cap 570 may comprise an opening mechanism for opening a container of plant based milk concentrate of any type, such as but not limited to any type of mechanism or opening device as described in relation to any embodiment herein. The cap 570 may comprise a dispensing mechanism of any type for dispensing a plant based milk concentrate from a container, such as but not limited to any type of dispensing mechanism or dispensing device as described in relation to any embodiment herein.

According to embodiments, the switch 573 may disengage a surface of part of the cap 570 in order to remove a part of the cap to reveal the internal cavity that receives a container of concentrate. According to embodiment, the switch 573 may be pressed in order to disengage the cap 570 from the bottle 560 in order that the cap 570 may be removed from the bottle 560.

The apparatus 500 shown in FIG. 12 may be about 25-40 cm in height. The apparatus 500 may be about 28-35 cm, 30-35 cm or 30-33 cm in height. The height may include the base 510, bottle 560 seated on the base 510, and cap 570 in place on the bottle 560. The base 510 may be connected to the cap 570 only indirectly via the bottle 560. There may be no direct connection of the cap 570 to the base 510.

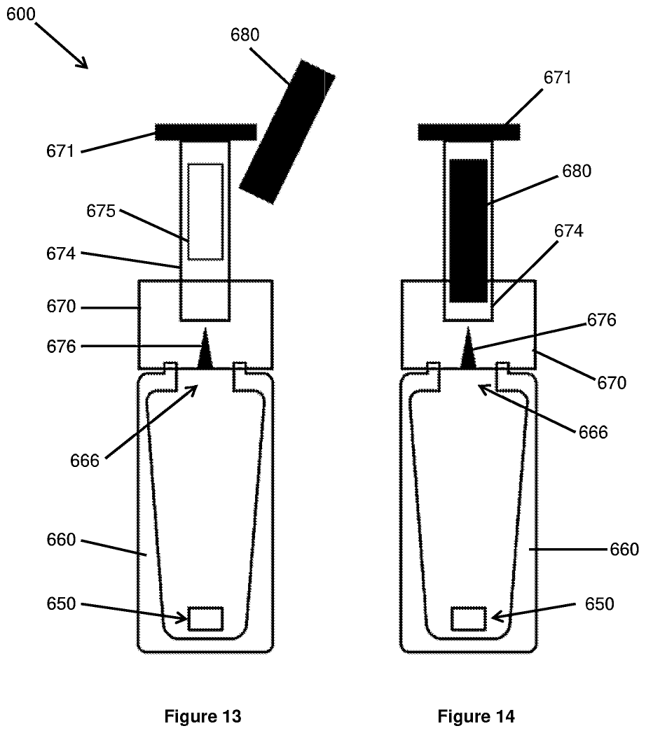

FIGS. 13 to 17 show an apparatus 600 including a bottle 660 and cap 670. The apparatus may be of the same type as shown in FIG. 9 or FIG. 12 or in other words the bottle 660 and cap 670 of FIGS. 13 to 17 may be the same as or compatible with the bottle 360, 560 and cap 361, 570 of either of FIGS. 9 and 12.

FIGS. 13 to 17 show a process involving at least inserting a container 680 into a cap 670, dispensing a concentrate 682 into bottle 660 and removing an empty container 681 from the cap 670. As shown in FIG. 13, bottle 660 includes a mixing head 650 at its base. The mixing head 650 may be of the type as previously described herein. The mixing head 650 may be a shearing head and/or may be configured to create a high shear. The mixing head 650 may comprise a rotating blade, the rotating blade being positioned within a stator screen. The stator screen has a plurality of holes. The holes in the stator screen may be about 0.5 to 5 mm in diameter, or may be about 0.5 to 3 mm in diameter, or may be about 1 to 2 mm in diameter or about 1 to 1.5 mm in diameter, or any suitable value above, below or within these sizes ranges. The bottle 660 is configured to be seated onto a base, such as the base shown in FIG. 9 or FIG. 12. The base contains a motor and there is a rotatable connection between the bottle and the base, such that the motor within the base may be used to rotate the rotating blade of the mixing head 650. Rotating the rotating blade of the mixing head 650 within the stator screen may create a vortex within a liquid in the bottle 660.

The bottle 660 has an opening 666. Cap 670 is configured such it encloses the opening 666 of the bottle 660. The cap 670 may be removably attachable to the bottle 660 over the opening 666. The cap 670 and bottle 660 may connect to one another via a screwing attachment and/or threaded engagement.

The cap 670 includes an internal cavity configured to receive a container 680. The container 680 may be a pod, a packet, a pouch, a sachet or any other type of small container of plant based milk concentrate. The container 680 shown in FIGS. 13 to 17 is a sachet. The concentrate within the container may be a powder, a paste and/or a concentrated liquid. The embodiment in FIGS. 13 to 17 shows a concentrate 682 that is a paste. The cap 670 includes an opener that is configured to open the container 680. In this embodiment, the opener is a piercer 676, which may take the form of a spike or sharpened member. The opener could include a blade. The opener may be a cutter. The container 680 may be opened by being pierced or cut.

The cap 670 has a top 671 that lifts from a body of the cap to reveal entrance 675. The entrance 675 is sized to receive container 680 into the internal cavity of the cap 670. The cap 670 includes shaft 674. The shaft 674 may connect the top 671 to the body of the cap 670. The shaft 674 may include the internal cavity into which a container 680 may be received. FIG. 14 shows the apparatus 600 when the container 680 has been received in the internal cavity of the cap 670 through the entrance 675. The container 680 is positioned within the internal cavity within shaft 674 in FIG. 14.

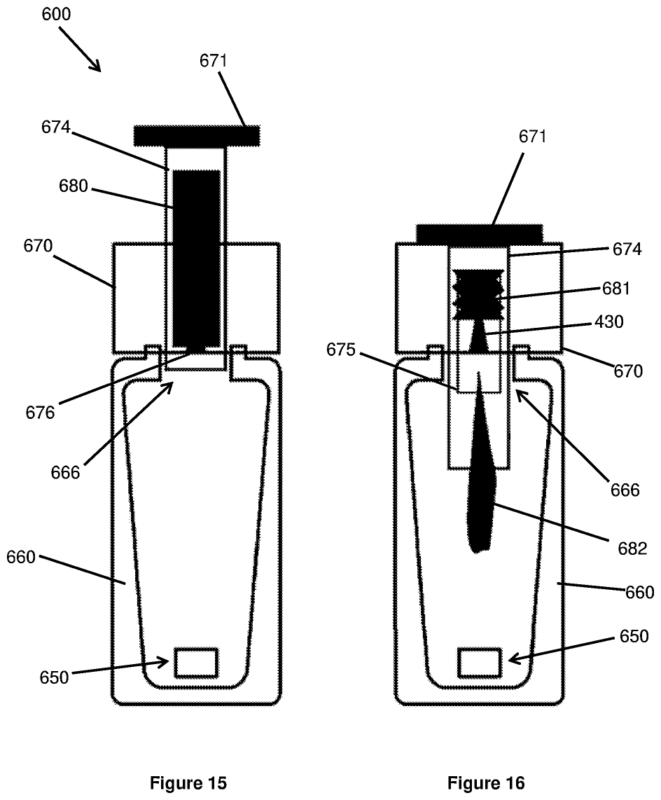

After the container 680 has been placed into the internal cavity within the cap 670, the container may be opened. An opening mechanism is initiated when the container 680 is in the cap 670. The opening mechanism may open the container 680 in order that its contents (concentrate) can be dispensed. The opening mechanism may be user initiated. The user may push or press an element of the cap 670 to cause the opening mechanism to open the container. In the embodiment shown in FIG. 15, the top 671 may be pressed by a user to push the container 680 onto the piercer 676. The top 671 and shaft 674 may function as a plunger. It is also possible that the container 680 may be caused to open by the cap 670 and powered by an internal power source in the cap 670. According to other possible embodiments, the container 680 may be opened prior to insertion in the cap 670.

Once the container 680 has been opened and/or pierced, or when an opened container is within the cap 670, the contents of the container 680 may be dispensed. In the embodiment shown in FIG. 16, the concentrate 682 is dispensed from the container 680 by further pressing the top 671. This causes the container 680 to deform/compress and for the concentrate 682 to be dispensed through the opening in the container 680. The cap 670 may have a first surface which contacts the container 680, in use, and which compresses the container 680 when the top 671 is pressed. According to embodiments the top 671 may be compressed by a user pushing on the top 671 or the cap 670 may have a mechanism that pushes the top 671. The cap 670 may have a handle that the user presses to dispense the contents of the container 680. It is also possible that, although FIG. 16 shows the container being compressed vertically (when in an upright orientation), the container 680 could be compressed in a horizontal direction or an oblique direction that is neither entirely horizontal or vertical. The container 680 may be compressed between two opposed surfaces of the cap 670 in order to cause the concentrate 682 to be dispensed. One of the opposed surfaces of the cap 670 may include at least one aperture through which the concentrate 682 may be pushed after being dispensed from the container 680. The force that compresses the container 680 may also cause the concentrate 682 to be pushed through the aperture(s) of the opposed surface. In the embodiment shown in FIGS. 13 to 17, one opposed surface is adjacent to the piercer 676 (or adjacent to the opener or mechanism that opens the container 680). The piercer 676 may include at least one aperture through which the concentrate 682 is pushed when the container 680 is compressed. The aperture(s) of the opposed surface and/or of the piercer 676 are in fluid communication with the internal cavity of the bottle 660 when the cap 670 is in place on the bottle 660. Thus, compressing the container 680 in the cap 670 will cause the concentrate 682 to be dispensed into the bottle 660.

After the concentrate 682 has been dispensed into the bottle 660 the bottle will contain both the concentrate 682 and a liquid, such as water. The liquid may be poured into the bottle 660 through the opening 666 when the cap 670 is either not in place or has been removed. The bottle 666 may contain the liquid, such as water, before the concentrate 682 is dispensed into the bottle 660. It is possible that the liquid, such as water, could be added to the bottle 660 after the concentrate 682 has been dispensed into the bottle 660. When the bottle contains both the concentrate 682 and liquid, such as water, the apparatus 600 may be activated to mix the concentrate and liquid together to form a plant based milk. As previously mentioned, the mixing head 650 may shear the mixture to create a smooth plant based milk and/or the mixing head 650 may be a shearing head. By shearing the concentrate 682 within the liquid the mixing head 650 may assist in emulsifying the concentrate 682. In other words, the concentrate 682 may be emulsified by the mixing head 650.

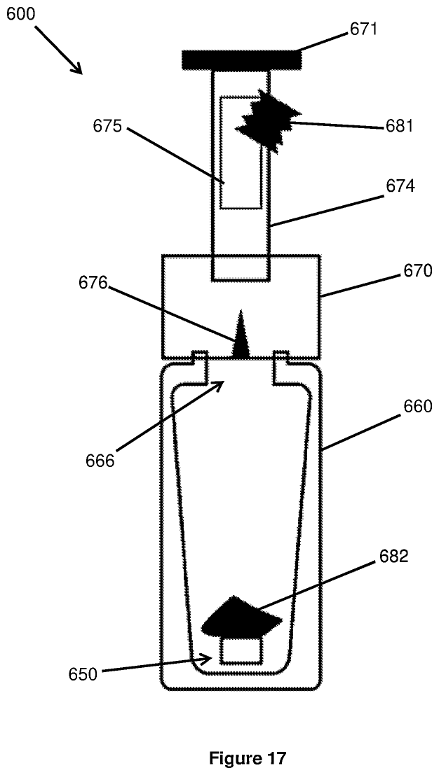

As shown in FIG. 17, once the concentrate 682 has been dispensed the container is empty 681 (or substantially empty). The empty container 681 may be removed from the container through the entrance 675. The top 671 may be extended outwardly from the body of the cap 670 to reveal the entrance 675. The empty container 681 may be removed from the cap 670 either before or after the concentrate 682 and liquid have been mixed in the bottle 660 to form the plant based milk.

According to other embodiments, the apparatus may not comprise a bottle cap. In such embodiments, the opening of the bottle may be located adjacent to the mixing head, which may be the only opening of the bottle. In such embodiments, the water and plant based milk concentrate may be inserted into the bottle before the mixing head has been placed into the bottle or before the bottle has been placed onto the base.

Unlike the embodiments shown in FIGS. 1, 2 and 5 to 8, the embodiments that are shown in FIGS. 9 to 17 relate to portable apparatus for forming a plant based milk form a concentrate. In these embodiments of FIGS. 9 to 17, the body of the apparatus or the apparatus housing may consist of a base without additional components. The entire body or housing in the embodiments of FIGS. 9 to 17 is located beneath the bottle in use, and/or no part of the body or housing is connected to the base extending upwardly from the base to be adjacent to the bottle along its length or above the bottle when the bottle is in position on the apparatus.

Also possible in embodiments where the apparatus is a portable apparatus is the inclusion of a bottle cap having a mechanism for dispensing a concentrate into the bottle. The bottle cap may be distinct from the base and/or may not be connected to the base. The bottle cap may receive a container of the concentrate. The bottle cap may include a means to open or pierce the container, such as an opener or piercer. Alternatively, a user may open or pierce the container before or after the container has been placed into the bottle cap. A user may dispense the contents of the container directly into an opening of the bottle from the container or from the container into a bottle cap of the apparatus. Once the container has been opened or pierced, the concentrate within the container may be dispensed into the bottle. The concentrate may be dispensed directly into the bottle or may be dispensed into one or more intermediary elements of the bottle cap and then into the bottle. A force may be applied to the container to dispense the concentrate therefrom. The concentrate may be pushed out of the container or may be such form the container, or otherwise dispensed in another manner.

The apparatus 600 may be configured to be easily disassembled for cleaning after usc.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed. For example, it will be understood that any of the features of the embodiments/examples shown or described in relation to each of the FIGS. 1 to 17 or otherwise provide herein may be combined with or replaced by any one or more features of any other figure(s), embodiment(s), or example(s) provided herein or equivalents thereof, within the scope of the present disclosure.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

### LIST OF DRAWING REFERENCES

The accompanying figure(s) show the following features:
10 Apparatus
12 Pour system
14 Tray
16 Receiving section
18 Recess
20 Container
30 Lower section of housing
40 Water tank
50 Mixing container
60 Milk container
62 Handle
100 Apparatus
110 Base
120 Main body
130 Upper section
131 Aperture in upper section
132 Opening mechanism
133 Receiving section
140 Bottle receiving area
150 Mixing head
151 Mixing blade
152 Stator screen
153 Blade arms
154 Blade surface
155 Apertures in stator screen
160 Bottle
161 Opening of bottle
180 Container
200 Apparatus
205 Power switch
206 Circuitry
210 Base
212 Rotor shaft
213 Connector
220 Main body
221 Central housing
222 Side wall
223 Side wall
224 Slot
225 Window
230 Upper section
231 Aperture
233 Container receiver
234 Top part
235 Front wall
236 Funnel
237 Receiver support
240 Bottle seat
241 Inner seat
242 Seal
243 Outer seat wall
250 Mixing head
260 Bottle
261 Lid
262 O-ring
263 Lower cap
264 Mixer insert
265 O-ring
266 Bottle opening
270 Receptacle
271 Receptacle handle
275 Lid
276 Lid cover
277 Lid handle
280 Container
290 Mechanism
291 Lever
292 Rack
293 Gear
294 Gear
297 Board
298 Slot
300 Apparatus
305 Power switch
310 Base
340 Bottle seat
350 Mixing head
360 Bottle
361 Lid
400 Apparatus
410 Base
418 Terminals
430 Container receiver
431 Side wall
432 Space (to receive container)
433 Piercer
434 Opening(s)
435 Outlet
436 Shaft
437 Opening
438 Terminal
439 Sensor
460 Bottle
466 Opening
480 Container
500 Apparatus
505 Power switch
510 Base
540 Bottle seat
550 Mixing head
560 Bottle
570 Cap
571 Cap top
572 Cap grip
573 Cap switch
600 Apparatus
650 Mixing head
660 Bottle
666 Bottle opening
670 Cap
671 Cap top
674 Cap shaft
675 Cap entrance
676 Piercer
680 Container
681 Empty container
682 Concentrate

What is claimed is:

1. An apparatus for forming a plant based milk, comprising:
a housing comprising a base that is configured to receive a vessel; and
a mixing head configured to mix a liquid and a concentrate in the vessel.

2. The apparatus of claim 1, wherein the apparatus is portable.

3. The apparatus of claim 1, wherein the mixing head comprises a rotor within a stator screen, and wherein the mixing head is configured to shear and/or emulsify the concentrate in the liquid.

4. The apparatus of claim 1, comprising the vessel.

5. The apparatus of claim 1, wherein the mixing head is within the vessel.

6. The apparatus of claim 1, further comprising a cap configured to enclose an opening of the vessel.

7. The apparatus of claim 6, wherein the cap is configured to receive a container of the concentrate.

8. The apparatus of claim 3, wherein the rotor comprises a plurality of rotating blades.

9. The apparatus of claim 3, wherein the stator screen comprises a plurality of apertures.

10. The apparatus of claim 9, wherein each aperture in the stator screen is about 1.0 mm to 1.5 mm in diameter.

11. The apparatus of claim 3, wherein at least one surface of the rotor has a small clearance from the stator screen to create a high sheer when the mixing head is in operation.

12. The apparatus of claim 3, further comprising a motor housed within the base, the motor being configured to rotate the rotor of the mixing head.

13. The apparatus of claim 12, wherein the motor is configured to rotate the rotor at a speed of at least 1000 RPM.

14. The apparatus of claim 12, wherein the base comprises a rechargeable battery configured to power the motor.

15. The apparatus of claim 7, wherein the cap comprises an entrance to an internal cavity configured to receive the container.

16. The apparatus of claim 15, wherein the cap comprises an opener and/or piercer that is configured to open and/or pierce the container within the internal cavity of the cap.

17. The apparatus of claim 15, wherein the cap comprises a mechanism to extract the concentrate from the container within the cap such that the concentrate is dispensed into the vessel.

18. The apparatus of claim 17, wherein the mechanism comprises two surfaces of the cap between which the internal cavity of the cap is at least partially located, wherein the mechanism is configured to compress the container between the two surfaces to cause the concentrate to be dispensed.

19. The apparatus of claim 18, wherein the apparatus includes a plunger which may be pressed to cause at least a first surface of the two surfaces to move towards a second surface of the two surfaces.

20. The apparatus of claim 15, wherein the cap comprises at least one aperture which provides a fluid communication between the internal cavity of the cap and an internal volume of the vessel, and through which a concentrate from a container in the internal cavity may be dispensed into the vessel.

21. The apparatus of claim 1, wherein the housing of the apparatus is located entirely adjacent to a first end of the vessel when the vessel is in position on the base, wherein the first end of the vessel comprises the mixing head.

22. The apparatus of claim 6, wherein the base is not directly connected to the cap.

23. The apparatus of claim 1, wherein the concentrate is in the form of a powder or a paste.

24. The apparatus of claim 1, wherein the concentrate is a plant based milk concentrate, and wherein the mixing head forms a plant based milk in the vessel by mixing the liquid and the concentrate.

25. The apparatus of claim 12, wherein a lower end of the vessel comprises a rotating connector which engages with a corresponding rotating connector located on the base when the vessel is seated on the base, the rotating connectors of the vessel and base being configured to transfer the rotational motion of the motor to the rotor of the mixing head.

26. The apparatus of claim 1, wherein the housing consists of the base.

27. A method for forming a plant based milk, comprising:
providing the apparatus of claim 1;
providing a plant based milk concentrate in a container;
providing a liquid, preferably water, in a vessel;
dispensing the plant based milk concentrate from the container into the liquid in the vessel; and
mixing the plant based milk concentrate with the liquid in the vessel to form a plant based milk.

28. The method for forming a plant based milk of claim 27, further comprising loading the vessel into a receiving area on the base of the apparatus.

29. A system for forming a plant based milk, comprising:
the apparatus of claim 1;
a container containing the concentrate; and
a vessel containing a liquid, preferably water;
wherein the container is received by a cap configured to enclose an opening of the vessel and the concentrate within the container is dispensed by the cap into the liquid in the vessel, and the mixing head mixes the concentrate with the liquid to form the plant based milk in the vessel.
